(19) United States
(12) Patent Application Publication
(10) Pub. No.: US 2010/0116760 A1
(43) Pub. Date: May 13, 2010

(54) MODULAR SHELVING AND METHODS FOR DISPLAYING RETAIL PRODUCTS

(76) Inventor: Huilin Min Fazzone, New York, NY (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/482,409

(22) Filed: Jun. 10, 2009

Related U.S. Application Data
(60) Provisional application No. 61/073,580, filed on Jun. 18, 2008.

(51) Int. Cl. A47F 7/00; G09F 3/00; A47B 97/00

(52) U.S. Cl. 211/49.1; 40/299.01; 362/127; 362/154

(57) ABSTRACT

A modular retail product display can be applied to, manufactured on, formed on, and/or used with a retail shelf. In various embodiments, the product display can be used to effectively display various retail products to consumers. In at least one embodiment, the product display can comprise a plurality of base sections which can be supported by a surface of the retail store shelf, and a shelf cap member which can be positioned proximate to a front portion of the retail store shelf. In at least one embodiment, the product display can further include at least one product locator tab which can be included on a portion of the product display to help direct consumers to various retail products and to aid in restocking the retail products.

### CROSS REFERENCE TO RELATED APPLICATION

This application claims the benefit of U.S. Provisional Application No. 61/073,580, filed Jun. 18, 2008.

### FIELD OF THE INVENTION

The present invention generally relates to shelving for displaying products and, more particularly, relates to modular shelving for displaying retail products to consumers.

### BACKGROUND OF THE INVENTION

“Consumer attractors” can be positioned near retail products in retail stores to draw consumers toward particular retail products and/or to educate the consumers about them. In at least one embodiment, consumer attractors can include retail store aisle displays which are configured to display retail products. In various embodiments, the consumer attractors can include signage, lights, brochures, and even discount coupon dispensers. These consumer attractors can be placed on and/or near retail product display areas in retail stores to encourage consumers to purchase various retail products positioned within the retail product display areas. One problem with current consumer attractors is that they must be sized to fit the retail product display areas of each particular retail store, thus limiting their full consumer attraction potential in various retail stores. For example, if a particular retail product company has a first retail product display area, in a first store, of four feet wide by three feet high, and a second retail product display area, in a second store, of six feet wide by eight feet high, the company may have to tailor-make a separate consumer attractor for each store because of the size differences between the first and second retail product display areas. What is needed is an improvement over the foregoing.

### SUMMARY OF THE INVENTION

In at least one general aspect, a modular retail product display kit can be applied to almost any existing shelf and/or set of shelves of a retail store regardless of the dimensions of a product display area. Each shelf can include an upwardly facing surface defined between a first end, a second end, a front side, and a rear side, for example. In various embodiments, the product display kit can be adapted to fit a retail store shelf regardless of the dimensions of the shelf, while at the same time creating a pleasing and advantageous presentation of the retail products to the consumer. In at least one embodiment, the product display kit may include features which can permit consumer education of a particular retail product to be matched with purchase inspiration for the same retail product, for example. In various embodiments, the product display kit can further include features that allow a consumer to easily navigate about the product display area to locate and purchase various retail products of interest. In at least one embodiment, the product display kit can be integrally formed on and/or manufactured with various modular product display areas to form a product display which can be used in a plurality of retail stores.

In at least one general aspect, a modular retail product display kit can comprise a plurality of base sections which can be configured to at least partially cover an upwardly facing surface of an existing retail store shelf such that the base sections can support a plurality of retail products thereon. In various embodiments, the product display kit can further comprise at least one shelf cap member, which can be positioned on a front side of at least one of the retail store shelves and at least one sample holder configured to receive and display a sample retail product to a consumer to encourage the consumer to purchase the retail product. In various embodiments, the shelf cap member and/or the sample holder can also be configured to receive and display an advertising message to the consumer to again encourage the consumer to purchase the retail products supported by the base sections. In at least one embodiment, the product display kit can further include a plurality of product locator tabs which can be positioned proximate to the front side of at least one of the retail store shelves. In such an embodiment, the product locator tabs can be configured to direct the consumer toward one of the retail products within the product display area and, additionally, can be configured to correspond with the sample retail product on the sample holder. In various embodiments, the product display kit can further include a retail product divider which can extend upwardly from at least one of the base sections. In at least one embodiment, the retail product divider can be configured to separate one type of retail product from another type of retail product to again aid the consumer in navigating about the product display area and to aid in restocking the product display area.

### BRIEF DESCRIPTION OF DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a perspective view of an exemplary product display area in accordance with one non-limiting embodiment;

FIG. 2 is a perspective view of a product display kit assembled on the product display area of FIG. 1 in accordance with one non-limiting embodiment of the present invention;

FIG. 3 is a front elevation view of the product display kit of FIG. 2;

FIG. 4 is a side elevation view of the product display kit of FIG. 2;

FIG. 5 is a top view of the product display kit of FIG. 2;

FIG. 6 is a perspective view of various components of a product display kit in an assembled configuration in accordance with one non-limiting embodiment of the present invention;

FIG. 7 is an exploded perspective view of various components of a product display kit in accordance with one non-limiting embodiment of the present invention;

FIG. 8 is another exploded perspective view of various components of a product display kit in accordance with one non-limiting embodiment of the present invention;

FIG. 9 is a top view of two interlockable base sections of a product display kit in accordance with one non-limiting embodiment of the present invention;

FIG. 10 is a top perspective view of the two interlockable base sections of FIG. 9;

FIG. 11 is a bottom perspective view of the two interlockable base sections of FIG. 9;

FIG. 12 is a top view of another base section of a product display kit in accordance with one non-limiting embodiment of the present invention;

FIG. 13 is a top view of yet another base section of a product display kit in accordance with one non-limiting embodiment of the present invention;

FIG. 14 is a top perspective view of a shelf cap member of a product display kit in accordance with one non-limiting embodiment of the present invention;

FIG. 15 is a bottom perspective view of the shelf cap member of FIG. 14;

FIG. 16 is an exploded perspective view of the shelf cap member of FIG. 14 being positioned to be engaged with a shelf cap receiver of a base section in accordance with one non-limiting embodiment of the present invention;

FIG. 17 is an exploded side view of the shelf cap member of FIG. 14 engaging a shelf cap receiver of a base section in accordance with one non-limiting embodiment of the present invention;

FIG. 18 is a perspective view of an advertising message banner configured to be attached to various shelf cap members of a product display kit in accordance with one non-limiting embodiment of the present invention;

FIG. 19 is a side view of a retail product divider positioned to be engaged with a base section of a product display kit in accordance with one non-limiting embodiment of the present invention;

FIG. 20 is a bottom perspective view of the retail product divider of FIG. 19 positioned to be engaged with the base section;

FIG. 21 is a top perspective view of the retail product divider of FIG. 19 positioned to be engaged with the base section;

FIG. 22 is a side view of a side portion of a product display kit in accordance with one non-limiting embodiment of the present invention;

FIG. 23 is a perspective view of the side portion of FIG. 22;

FIG. 24 is a top view of the side portion of FIG. 22;

FIG. 25 is a bottom perspective view of the side portion of FIG. 22 positioned to be engaged with a base section of a product display kit in accordance with one non-limiting embodiment of the present invention;

FIG. 26 is a top perspective view of the side portion of FIG. 22 positioned to be engaged with a base section of a product display kit in accordance with one non-limiting embodiment of the present invention;

FIG. 27 is a perspective view of a shelf fin of a product display kit in accordance with one non-limiting embodiment of the present invention;

FIG. 28 is a side view of the shelf fin of FIG. 27;

FIG. 29 is a side view of the shelf fin of FIG. 27 positioned to be engaged with a shelf cap receiver of a base section of a product display kit in accordance with one non-limiting embodiment of the present invention;

FIG. 30 is an exploded side view of a connection between a connection member of the shelf fin of FIG. 27 and a shelf cap receiver of a product display kit in accordance with one non-limiting embodiment of the present invention;

FIG. 31 is an exploded side view of a connection between a connection member of the shelf fin of FIG. 27 and a shelf cap receiver of a product display kit in accordance with one non-limiting embodiment of the present invention;

FIG. 32 is an exploded view of advertising displays being connected to the shelf cap receiver of a product display kit in accordance with one non-limiting embodiment of the present invention;

FIG. 33 is an exploded perspective view of the connection of various components of a product display kit to a base section of the product display kit in accordance with one non-limiting embodiment of the present invention;

FIG. 34 is a top perspective view of a sample holder of a product display kit in accordance with one non-limiting embodiment of the present invention;

FIG. 35 is a bottom perspective view of the sample holder of FIG. 34;

FIG. 36 is a perspective view of another sample holder of a product display kit in accordance with one non-limiting embodiment of the present invention;

FIG. 37 is another perspective view of the sample holder of FIG. 36;

FIG. 38 is a perspective view of a product locator tab of a product display kit in accordance with one non-limiting embodiment of the present invention;

FIG. 39 is a side view of the product locator tab of FIG. 38;

FIG. 40 is a perspective view of a retail product logo portion attached to the product display area of FIG. 1 in accordance with one non-limiting embodiment of the present invention;

FIG. 41 is a perspective view of another retail product logo portion attached to another product display area in accordance with one non-limiting embodiment of the present invention;

FIG. 42 is a perspective view of yet another retail product logo portion attached to yet another product display in accordance with one non-limiting embodiment of the present invention;

FIG. 43 is a perspective view of the retail product logo portion of FIG. 40;

FIG. 44 is a side view of a connection between the retail product logo portion of FIG. 40 and a shelf of the product display area of FIG. 1 in accordance with one non-limiting embodiment of the present invention;

FIG. 45 is a perspective view of a bracket attached to the retail product logo portion of FIG. 41 in accordance with one non-limiting embodiment of the present invention;

FIG. 46 is a perspective view of the bracket of FIG. 45 being attached to shelf strips of the product display area in accordance with one non-limiting embodiment of the present invention;

FIG. 47 is a front perspective view of another bracket attached to the retail product logo portion of FIG. 42 in accordance with one non-limiting embodiment of the present invention;

FIG. 48 is a rear perspective view of the bracket and retail product logo portion of FIG. 47;

FIG. 49 is a front view of an adaptable retail product logo portion of a product display kit in accordance with one non-limiting embodiment of the present invention;

FIG. 50 is a perspective view of a product display kit in accordance with one non-limiting embodiment of the present invention;

FIG. 51 is a front elevation view of the product display kit of FIG. 50;

FIG. 52 is a side elevation view of the product display kit of FIG. 50;

FIG. 53 is an exploded perspective view of various components of a product display kit in accordance with one non-limiting embodiment of the present invention;

FIG. 54 is a top view of various components of a product display kit in an assembled configuration in accordance with one non-limiting embodiment of the present invention;

FIG. 55 is a perspective view of the various components of the product display kit of FIG. 54;

FIG. 56 is a perspective view of an advertising display of the product display kit of FIG. 54;

FIG. 57 is an exploded perspective view of various components positioned to be attached to a shelf cap receiver of a base portion of a product display kit in accordance with one non-limiting embodiment of the present invention;

FIG. 58 is a top view of a sample retail product retaining member of a product display kit in accordance with one non-limiting embodiment of the present invention;

FIG. 59 is a side view of the sample retail product retaining member of FIG. 58;

FIG. 60 is a perspective view of the sample retail product retaining member of FIG. 58;

FIG. 61 is an exploded perspective view of a column member positioned to be attached to a product display kit in accordance with one non-limiting embodiment of the present invention;

FIG. 62 is a perspective view of the column member of FIG. 61;

FIG. 63 is another perspective view of the column member of FIG. 61;

FIG. 64 is a perspective view of a retail product logo portion and two corner members of a product display kit assembled on a product display area in accordance with one non-limiting embodiment of the present invention;

FIG. 65 is a perspective view of the retail product logo portion and the two corner members of FIG. 64;

FIG. 66 is a perspective view of one of the corner members of FIG. 64;

FIG. 67 is another perspective view of one of the corner members of FIG. 64; and

FIG. 68 is a perspective view of a lighting system for a product display kit in accordance with one non-limiting embodiment of the present invention.

### DETAILED DESCRIPTION OF THE INVENTION

Certain exemplary embodiments will now be described to provide an overall understanding of the principles of the structure, function, manufacture, and use of the product displays, the product display kits, and the methods disclosed herein. One or more examples of these embodiments are illustrated in the accompanying drawings. Those of ordinary skill in the art will understand that the product displays, the product display kits, and the methods specifically described herein and illustrated in the accompanying drawings are non-limiting exemplary embodiments and that the scope of the various embodiments of the present invention is defined solely by the claims. The features illustrated or described in connection with one exemplary embodiment may be combined with the features of other exemplary embodiments. Such modifications and variations are intended to be included within the scope of the present invention.

Companies that manufacture retail products, such as beauty care products, skin care products, and/or hair care products, for example, can display their products to consumers in product display areas within various retail stores. In various embodiments, the product display areas may include one shelf, a plurality of shelves supported by a frame, a plurality of sets of shelves, and/or other various product display platforms, for example. These product display areas can also include different dimensions, e.g., height, width, length, depth, which can make it difficult for the companies to design consumer attractors that universally fit all of the various product display areas. In various exemplary embodiments, referring to FIG. 1, an example of a product display area 10, without a product display kit positioned thereon, can include a frame having a rear wall 12, a plurality of shelf hanger strips 14, and a plurality of shelves 16 configured to be attached to the shelf hanger strips 14 using any suitable connection members, such as hooks and/or brackets, for example. In at least one embodiment, each shelf 16 can include an upwardly facing surface 18 and a downwardly facing surface 20, for example. In various embodiments, the shelves 16 can be moved upwardly and/or downwardly relative to the rear wall 12 simply by repositioning the various shelves 16 on the shelf hanger strips 14. Once the shelves 16 are configured to a suitable arrangement within the product display area 10, various retail products can be positioned on the upwardly facing surface 18 of any of the various shelves 16 to display the retail products to consumers. Generally speaking, the illustrated configuration of retail product display areas can be somewhat standard throughout most retail stores; however some retail product display areas can include only one or more shelves. In other various embodiments, other known types of retail product display areas can be used. In various embodiments, the dimensions of the retail product display areas can commonly differ from retail store to retail store.

Accordingly, in various embodiments, a product display kit can be applied to various product display areas in many retail stores regardless of the dimensions of the various product display areas. The product display kit can be used to display the retail products in a manner which promotes the retail products, educates consumers about the retail products, and/or inspires consumers to purchase the retail products, for example. In at least one embodiment, the product display kit can include features that allow easily navigation by consumers about the product display area and permit clear retail product presentation. Such advertising and retail product presentation techniques have the goal of attracting consumers to the retail products such that the consumers purchase the retail products.

In various embodiments, the product display kits described herein can be integrally formed on, formed with, and/or manufactured as a modular product display. In such an embodiment, the product displays can be used in retail stores, much like the product display kits described herein. These modular product displays can include some and/or all of the features of the product display areas and the product display kits described herein. For purposes of clarity, and without limitation, only the product display kits will be described in detail, although those of ordinary skill in the art will recognize that modular product displays can be manufactured to include the features of the product display kits.

Further to the above, a consumer's first reaction, upon viewing a retail product, is one element in determining whether the consumer will purchase a company's product or buy a competitor's product. This consumer reaction can be referred to as the First Moment of Truth (FMOT). Further, any prior use of the retail product by the consumer can be referred to as the Second Moment of Truth (SMOT). The SMOT is the assessment of retail product usage by the consumer or a usage experience by someone else that has been relayed to the consumer, such as by word-of-mouth, Internet chat room, product reviews, or the like. The SMOT can refer to both the time of product use by the consumer, and product benefits lasting for a period of time after the consumer has used the product.

FMOT and SMOT can involve aesthetics, brand equity, textual and/or sensorial communications, and/or consumer benefits, among other things. Other factors can include the appearance of the retail product at the point of sale or in a product display area near the point of sale, the visual appearance (logo, copyrights, trademarks, or slogans), olfactory (smell), and aural (sound) features communicated by and in support of the brand equity, and the graphic, verbal, pictorial or textual communication to the consumer such as value, unit price, performance, prestige, and convenience, for example. The communication can also focus on how a message is transmitted to the consumer, e.g., through a design, logo, text, pictures, imagery, and the like.

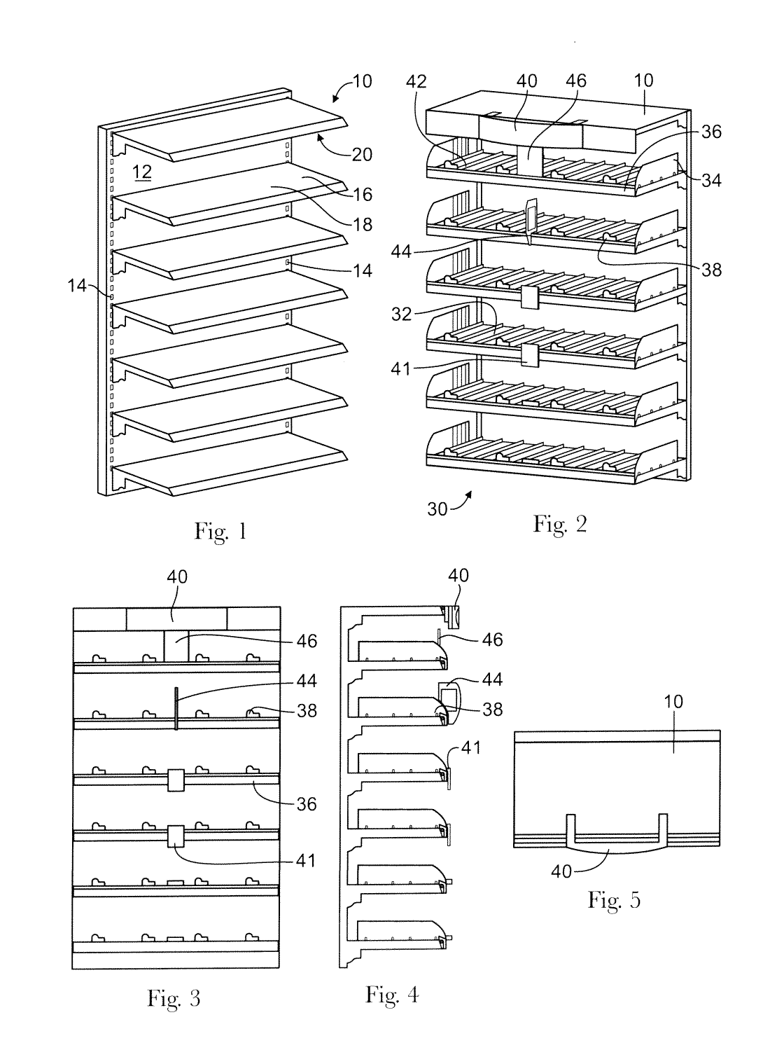

With the above FMOT and SMOT theories in mind, referring to FIGS. 2-5, a modular retail product display kit 30 can be configured to be positioned on an existing shelf and/or set of existing retail store shelves, such as the product display area 10, for example. In at least one embodiment, the product display kit 30 can include at least one base section 32, at least one side portion 34, at least one shelf cap member 36, at least one product locator tab 38, a retail product logo portion 40, at least one product sample holder 41, at least one retail product divider 42, at least one shelf fin 44, and/or at least one advertising display 46. In such an embodiment, the product display kit 30 can be adaptable such that it can be fitted to almost any existing product display area in any retail store and be used to increase a consumer's attraction to various retail products.

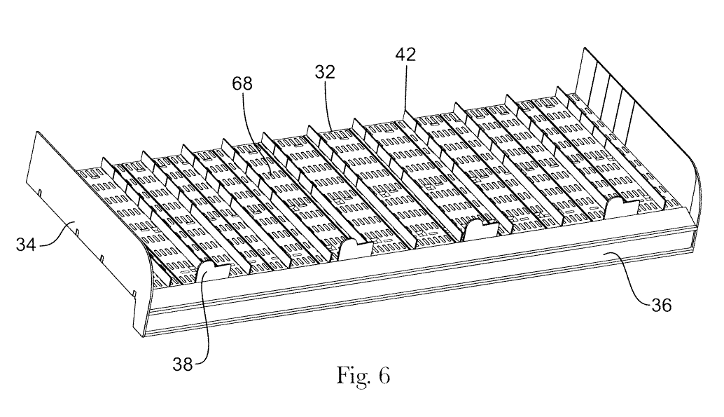

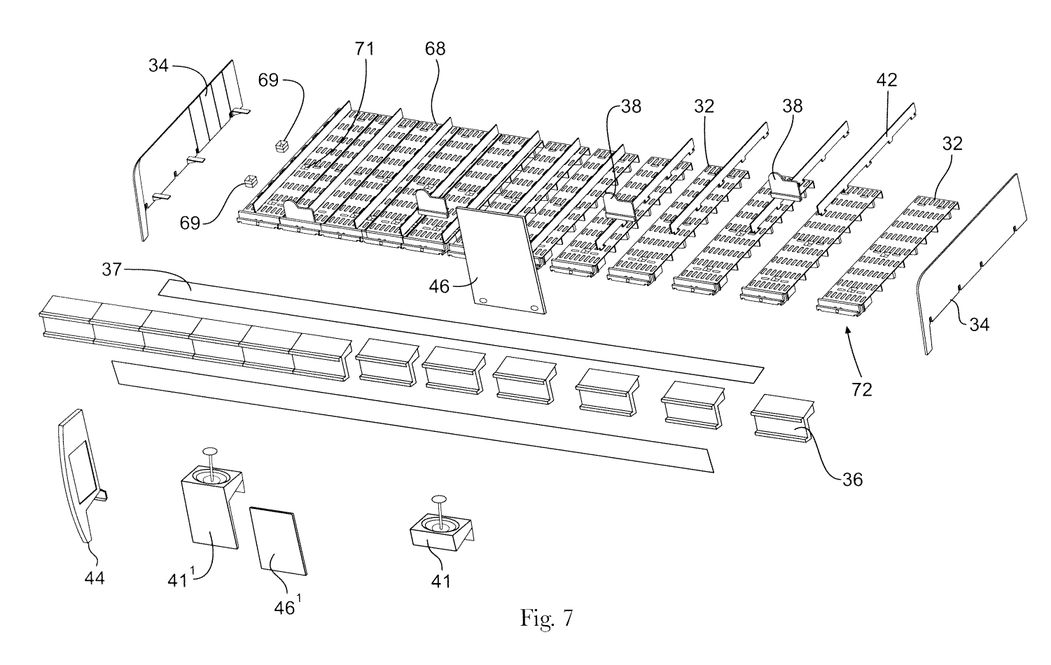

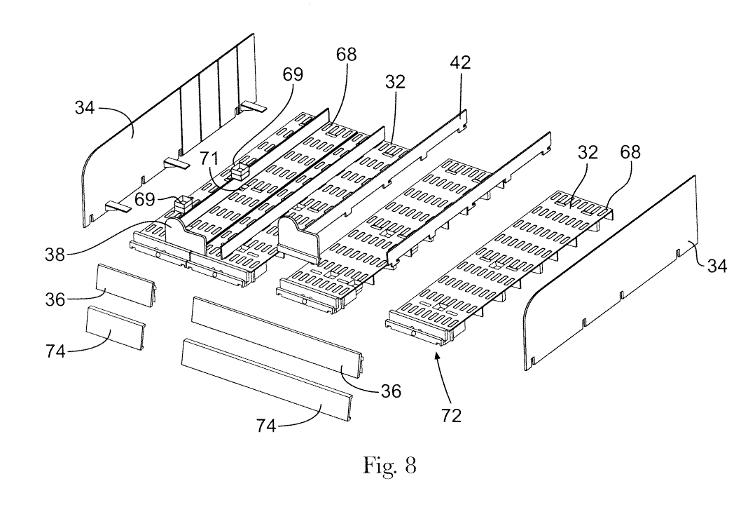

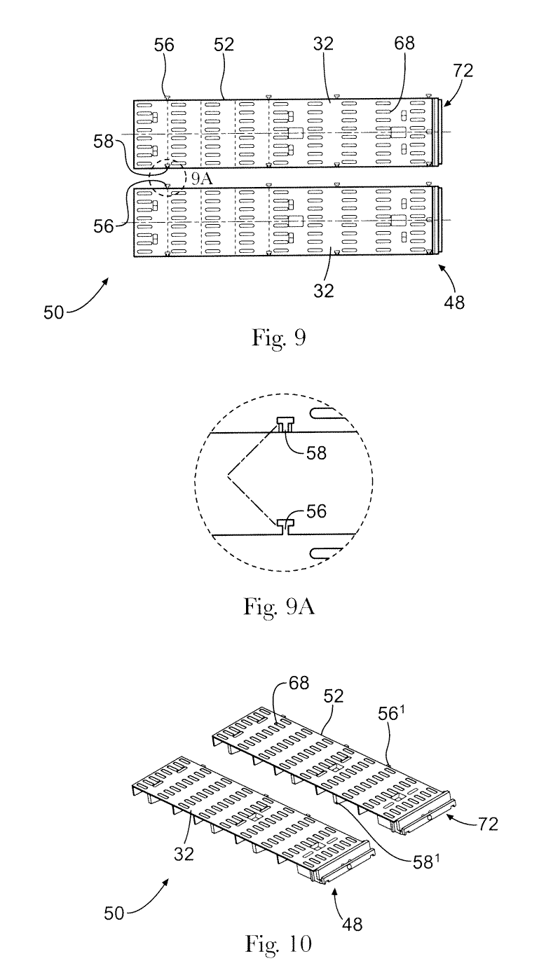

Further to the above, in various embodiments, referring to FIGS. 6-11, the base sections 32 can be positioned on and/or supported by the upwardly facing surface 18 of the shelves 16 such that the base sections can support retail products thereon. In at least one embodiment, the base sections 32 can further support, and/or act as a base to, at least some of the other various components of the product display kit, such as the retail product dividers 42, for example. In at least one exemplary embodiment, referring to FIG. 6, the base sections 32 and other various components of the product display kit are illustrated in an assembled configuration. In at least one embodiment, FIGS. 7 and 8 illustrate the various components of the product display kit 30, including the plurality of base sections 32, in an unassembled configuration. In various embodiments, referring to FIGS. 9-11, each base section 32 can include a first end 48, a second end 50, a first side wall 52, and a second side wall 54. In such an embodiment, the first or second side walls 52 and 54 of each base section 32 can include tabs 56 and/or 56′ extending therefrom which can be interlocked with tab receivers 58 and/or 58′ respectively. In at least one embodiment, the tab receivers can be located on and/or defined in an opposing first or second side wall of another adjacent base section 32. In such an embodiment, the tabs 56 and/or 56′ can be engaged with, press-fit, and/or snap-fit with the corresponding tab receivers 58 and/or 58′, for example, to thereby join two base sections 32 to one another, for example. In various embodiments, the interlockability of the one or more base sections 32 can allow the product display kit 30 to be configured for use on a retail store shelf having any width, for example, in that any number of base sections 32 having any width can be provided in the product display kit 30 to cover the upwardly facing surface 18 of at least one retail store shelf.

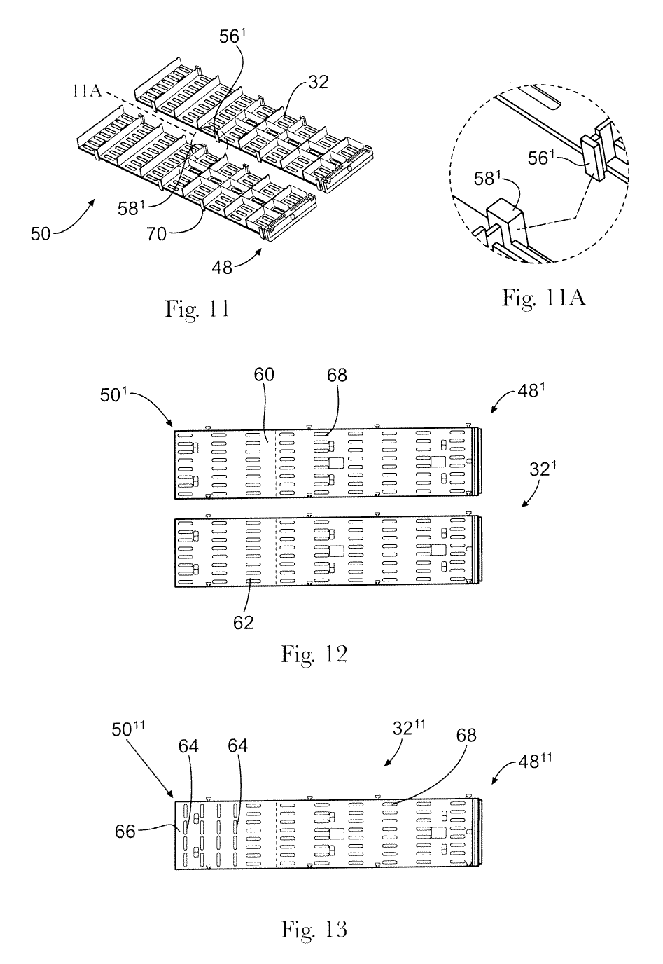

In other various embodiments, the base sections can be adapted to fit various retail shelves in other ways while still including the features of the base section 32 discussed above. In at least one embodiment, referring to FIG. 12, a first portion 60 of a base section 32′ can be enveloped within a second portion 62 of the base section 32′ such that the first portion 60 can be selectively slid into and/or out of the second portion 62 to thereby allow the base section 32′ to expand and/or retract relative to a dimension, e.g., width, depth, of a retail store shelf. In such an embodiment, the base section 32′ can be used to easily adapt the product display kit 30 to any size shelf. In various embodiments, base section 32 and base section 32′ can be used in conjunction with each other and/or base sections 32 and 32′ can be used alone, for example. In further various embodiments, referring to FIG. 13, a base section 32″ can include a plurality of recesses 64, perforations, and/or score marks defined therein, wherein the recesses, perforations, and/or score marks can be positioned parallel to, or substantially parallel to, the first and second ends 48″ and 50″ of the base section 32″. In at least one embodiment, a portion 66 of the base section can be separated from the rest of the base section 32″ along the recesses 64, perforations, and/or score marks to thereby adjust a dimension of the base sections 32″ relative to a dimension of a particular retail store shelf, for example. Although the recesses, perforations 64, and/or score marks are illustrated in one configuration suitable for adjustment in one direction, other recesses, perforations, and/or score marks can be positioned in other suitable directions for adjustment of the base section 32″ in other directions. In various embodiments, base sections 32″ can be used in conjunction with base sections 32 and/or 32′ and/or used alone. In at least one embodiment, a base section can include all or some of the features of the base sections 32, 32′, and 32″ described above. For purposes of clarity, and without limitation, only base sections 32 will be referred to hereafter.

In various embodiments, still referring to FIGS. 6-11, the base sections 32 can further include apertures 68 defined therein, wherein the apertures can be configured to receive portions of other components of the product display kit 30, such as the retail product divider 42, the side portions 34, and the product locator tabs 38, for example, to provide flexibility in positioning the various components relative to the shelf and/or base sections 32. In at least one embodiment, referring to FIG. 11, the base sections 32 can further include risers 70 configured to maintain the base sections 32 at a distance above the upwardly facing surface 18 of at least one retail store shelf, for example. In further various embodiments, the base sections 32 can include shelf cap receivers 72 positioned relative to and/or on the first end 48. In at least one embodiment, the shelf cap receivers 72 can be configured to receive at least one shelf cap member 36 and/or other various components of the product display kit, for example.

In various embodiments, referring to FIGS. 7, 8, and 53, the product display kit can further include an attachment member 69 configured to attach the base sections 32 to an upwardly facing surface of at least one shelf. In at least one embodiment, the attachment member 69 can include an adhesive (not illustrated) position on at least a portion of a bottom surface thereof. In such an embodiment, a peelable membrane can be placed over the adhesive to prevent the adhesive from being activating and/or bonding prior to use. In various embodiments, the attachment member 69 can include features which can be configured to engage at least one side wall of a recess 71 defined through the base sections. In at least one embodiment, the attachment member 69 can be press-fit, snap-fit, and/or frictionally engaged with the side wall of the recess 71. In such an embodiment, as the attachment member 69 engages the side wall of the recess 71, the adhesive can engage the upwardly facing surface of at least one shelf to bond thereto. As a result, the base sections can be attached to at least one shelf owing to the adhesive and attachment member/recess engagement. Such an attachment of the base sections to at least one shelf can eliminate the need to apply an adhesive to the entire, or a large portion of, the bottom surface of the base sections, for example. Further, such an attachment member can be used to level and align the base sections with the upwardly facing surface of at least one of the shelves owing to the attachment member's engagement to both the upwardly facing surface of the shelf, through the adhesive, and its engagement to the side wall of the recess.

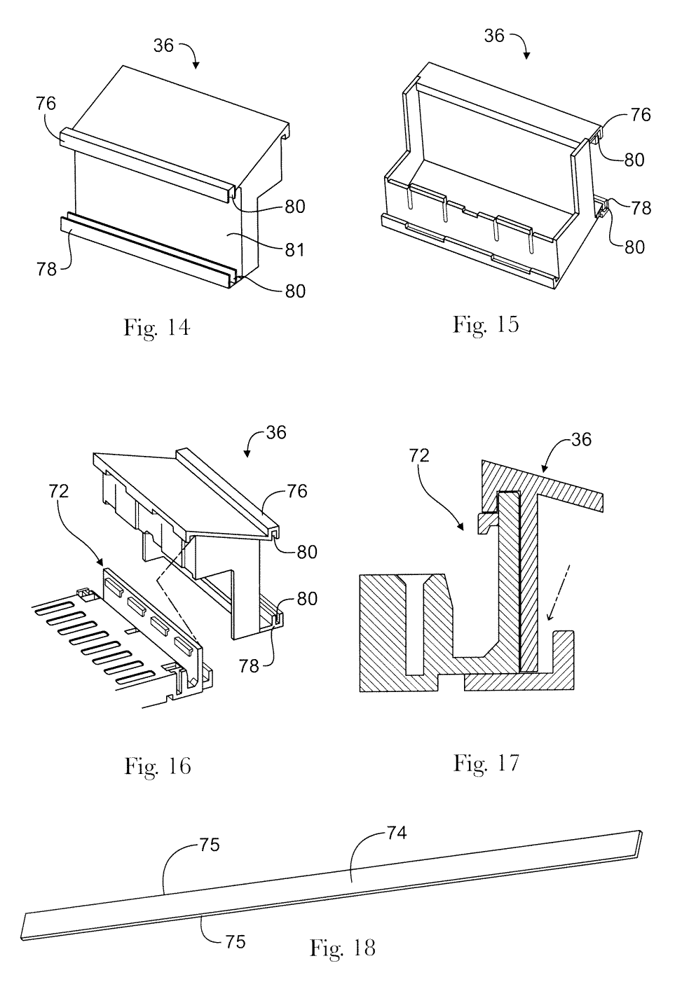

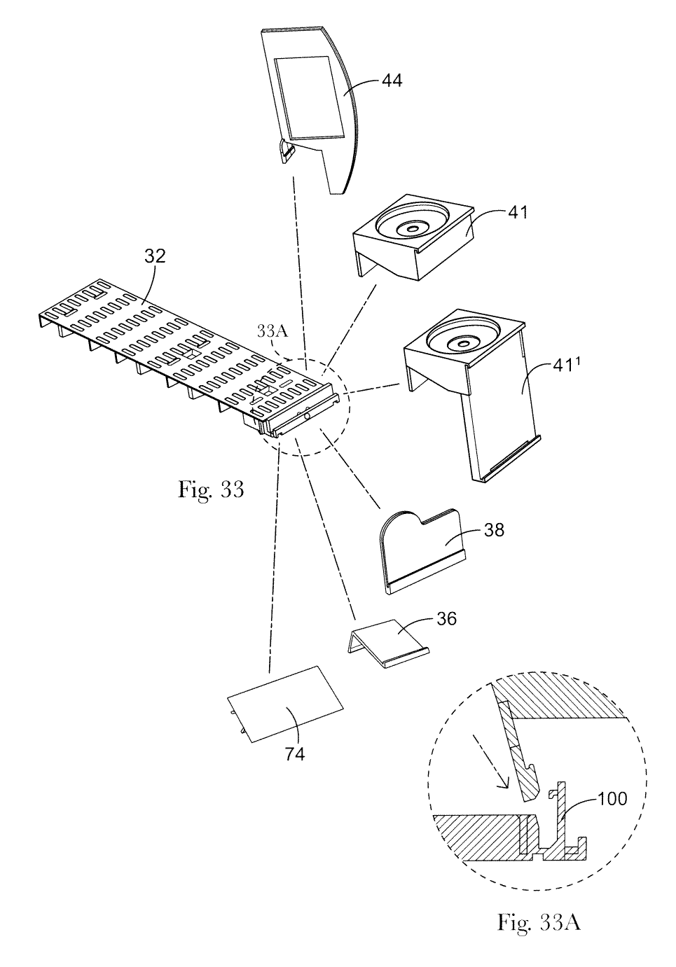

In various embodiments, referring to FIGS. 6-8 and 14-17, the product display kit 30 can include at least one, and preferably more than one, shelf cap member 36 having a top portion 37 for aesthetic purposes. In at least one embodiment, referring to FIGS. 14-17, the shelf cap member 36 can be configured to be positioned on and/or relative to the first end 48 of the base sections 32 and be engaged, press-fit, and/or snap-fit to one or more shelf cap receivers 72. In other various embodiments, the shelf cap 36 can be attached to the front portion of the shelf and/or a portion of the base section 32, for example. In various embodiments, the shelf cap members 36 can include any suitable dimensions, e.g., width or length, and/or the product display kit can be provided with shelf cap members 36 of a plurality of varying dimensions, for example, to provide adaptability and modularity to the product display kit 30. In at least one embodiment, referring to FIG. 18, the shelf cap members 36 can be configured to hold an advertising message banner 74 to thereby display a first advertising message to a consumer. In such an embodiment, the shelf cap members 36 can include a first projection 76 and a second projection 78, wherein the first and second projections can each define slots 80, and wherein the slots 80 can be configured to receive edge portions 75 of the advertising message banner 74, for example, to hold the banner to the shelf cap members. In other various embodiments, the first advertising message banner 74 can be attached to a front face 81 of the shelf cap members 36 in any suitable fashion, such as using an adhesive or magnets, for example. In at least one embodiment, referring to FIG. 33, a product sample holders 41 and/or 41′, a product locator tab 38, a shelf fin 44, an advertising display 46, and/or other various components of the product display kit can also be attached to the shelf cap members 36 and/or to the shelf cap receivers 72, for example, as discussed in further detail below. In such an embodiment, the above-listed components can be engaged with, connected to, press-fit, and/or snap-fit with the shelf cap members 36 and/or the shelf cap receivers 72, for example.

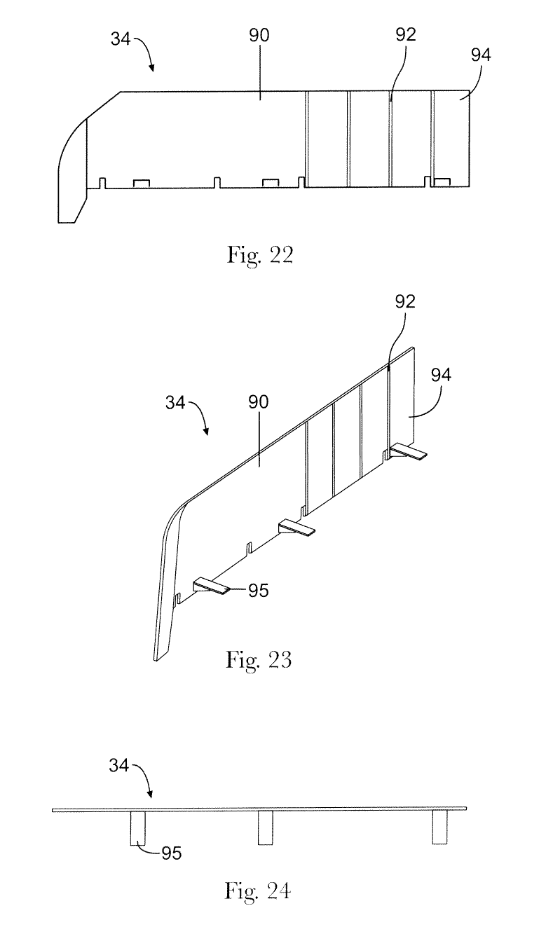

In various embodiments, the product display kit 30 can further include retail product dividers 42 which can be configured to separate various retail products located in different portions of the product display area and/or positioned on or supported by the base sections 32. In at least one embodiment, referring to FIGS. 6-8 and 19-21, the retail product dividers 42, in combination with the product locator tabs 38, can be used to help consumers quickly navigate through the product display area with the product display kit and locate the retail products they wish to purchase, for example. In various embodiments, the retail product dividers 42 can include an elongate body 82. In at least one embodiment, a plurality of recesses 84, perforations, and/or score marks can be defined in the elongate body 82 in any suitable direction. In such an embodiment, a portion 86 of the elongate body can be separated and/or broken from the elongate body 82 along the recesses 84, perforations, and/or score marks to adapt the retail product dividers 42 to fit a dimension of a retail store shelf. As an example, the portion 86 can include a length of 5 mm to 100 mm. Of course, those of skill in the art will recognize that any other suitable portion length is within the scope of the present disclosure. In such a fashion, the retail product dividers 42 can be easily adapted to fit a dimension of any product display areas in any retail stores.

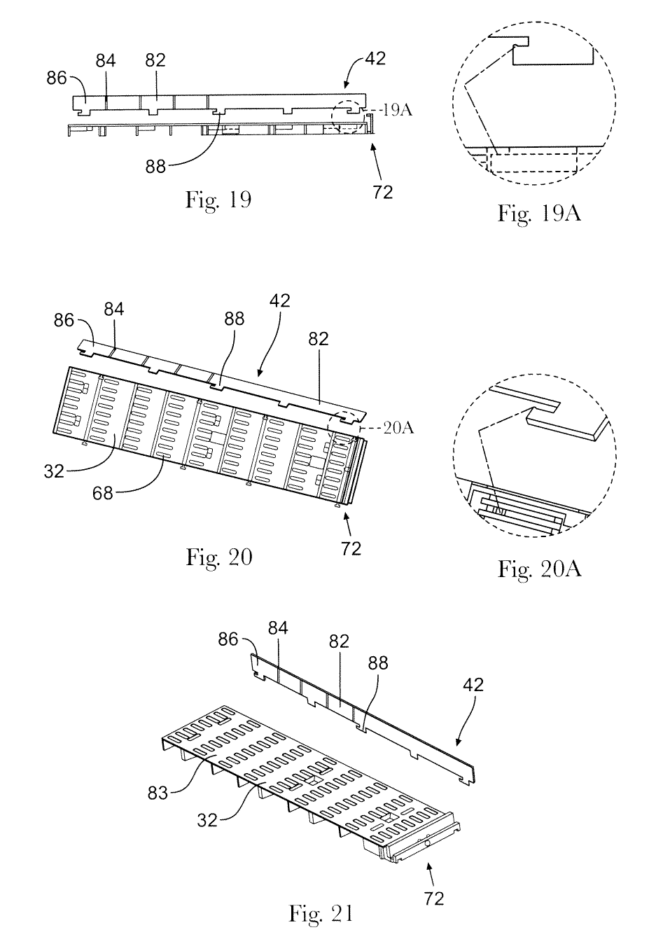

Further to the above, in various embodiments, the retail product dividers 42 can also include at least one hook member 88 extending from the elongate body 82. In such an embodiment, referring to FIGS. 19-21, the hook member 88 can be configured to be engaged with at least some of the apertures 68 in the base sections 32 to retain the retail product dividers to the base sections. In other various embodiments, either in lieu of or in addition to the hook members, the retail product dividers 42 can be attached to the base sections 32 near the first end 48 and the second end 50 of the base section 32, for example, using any suitable connection members. In other various embodiments, the retail product dividers can be used in conjunction with the base sections and/or attached thereto in any suitable configuration. In any event, the elongate body 82 of the retail product dividers 42 can be positioned perpendicular to, or substantially perpendicular to, a top face 83 of the base sections 32. In such a fashion, the positioning of the retail product dividers 42 can be used to separate various retail products positioned in various portions of the product display kit thereby allowing ease in restocking the various products and ease in consumer navigation between the various retail products.

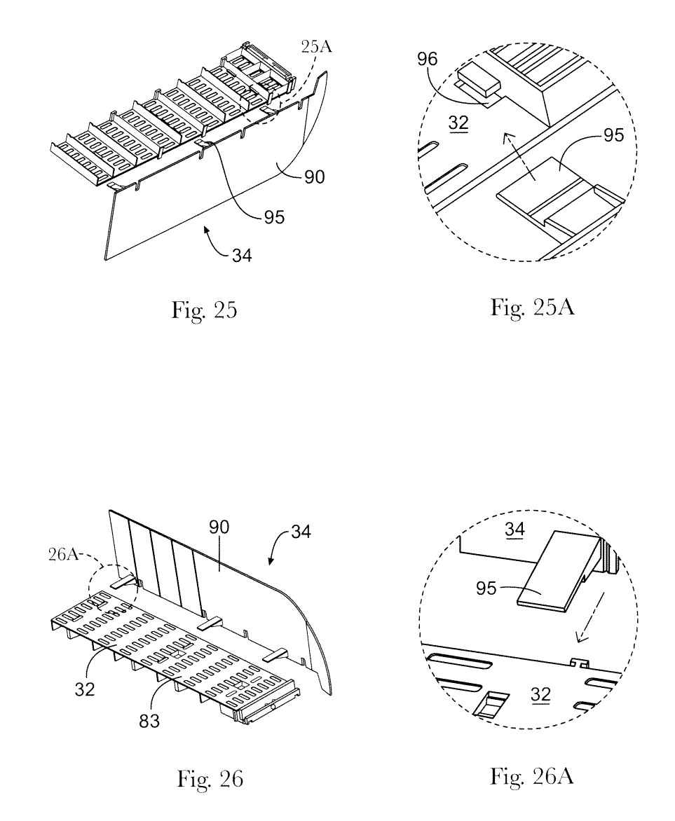

Further to the above, in various embodiments, the product display kit can further comprise at least one side portion 34 which can be configured to prevent, or at least inhibit, the retail products from falling off the shelf and/or spilling over into other product display areas, for example. In at least one embodiment, at least one side portion can be positioned on one or more shelves, for example. In various embodiments, referring to FIGS. 2, 4, 6-8, and 22-26, the side portions 34 can include an elongate frame 90 configured to be attached to at least one of the base sections 32 and/or a portion of the product display area. In at least one embodiment, referring to FIGS. 22 and 23, the elongate frame 90 can include a plurality of recesses 92, perforations, and/or score marks defined therein and extending in any suitable direction. In such an embodiment, portions 94 of the elongate frame 90 can be separated from the elongate frame 90 along the recesses 92, perforations, and/or score marks to adapt a dimension, e.g., width, depth, and/or length, of the side portions 34 to fit a dimension of a particular retail store shelf. Similar to the above, the separation of the portions 94 can allow the side portions to be very easily adapted for use with almost any retail store shelf having various dimensions, for example. In various embodiments, the side portions 34 can further comprise tabs 95 extending from a lower portion of the elongate frame 90. In at least one embodiment, referring to FIGS. 22-26, the tabs 95 can be used to connect the side portions 34 to the base sections 32 by engaging connection members 96 of the base sections 32. In such a fashion, the side portions 34 can be assembled to the base sections 32, in a direction perpendicular to, or substantially perpendicular to, the top face 83 of the base section 32. Of course, in other various embodiments, other connection members can be used to attach the side portions 34 to the base sections 32 and/or other portions of the product display kit and/or the product display area.

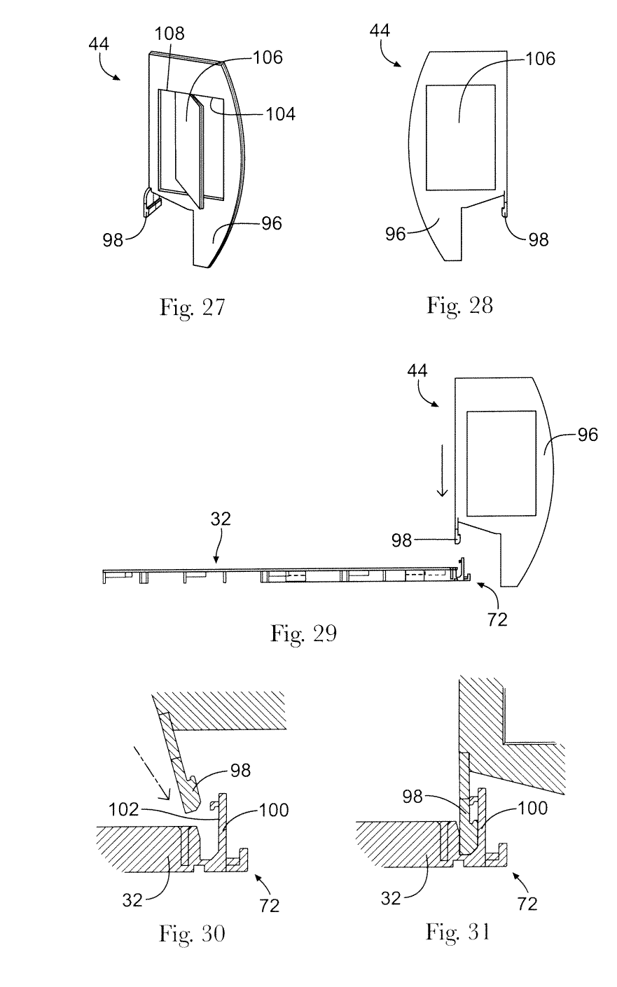

In various embodiments, referring to FIGS. 2, 7, and 27-31, the product display kit can also include a shelf fin configured to display consumer product information to a consumer. In such an embodiment, the shelf fin can allow retail product information for various retail products to be displayed on both sides of a retail product information display and/or in any location along the projection 100. In at least one embodiment, referring to FIGS. 27-31, the shelf fin 44 can include a body 96 and a connecting tab 98 extending from a lower portion of the body. In such an embodiment, the connecting tab 98 can be used to engage the shelf fin 44 with the shelf cap receiver 72 and/or a portion of the base section 32, for example, to retain the shelf fin to the product display kit. In various embodiments, the shelf cap receiver 72 can include a projection 100 defining a recess 102, wherein the connecting tab 98 can be engaged with the recess and be latched onto a portion of the projection 100. In other various embodiments, the connecting tab 98 can be press-fit and/or snap-fit to the shelf cap receiver 72 and/or a portion of the base sections 32, for example. In still other various embodiments, the connecting tab 98 can be attached to the shelves, the base sections 32, and/or the shelf cap receivers 72 in any suitable manner. In various embodiments, the body 96 of the shelf fin 44 can include an aperture 104 configured to receive a retail product information display 106. In at least one embodiment, the retail product information display 106 can be attached to at least one side wall 108 of the aperture 104 using at least one pin or other connection member, such that the retail product information display can be configured to pivot and/or move relative to the body 96 of the shelf fin 44, for example.

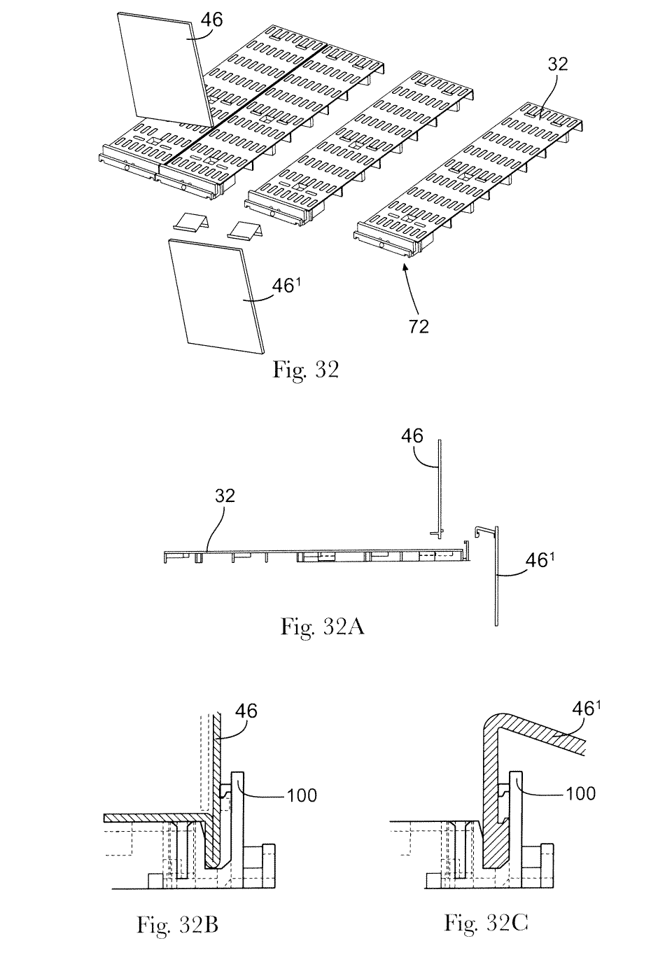

In addition to the shelf fin described above, in other various embodiments, at least one advertising display 46 or 46′ can be used to display a retail product brand, retail product information, and/or a retail product advertising message to a consumer. In at least one embodiment, referring to FIGS. 2, 3, 7, and 32, the advertising display 46 can be positioned on or near the front end 48 of the base sections 32. In such embodiments, the advertising display 46 can be engaged with the shelf cap receiver 72, the front end 48 of the base sections 32, and/or be otherwise engaged proximate to a front portion of a retail store shelf. In various embodiments, the advertising display 46 can be engaged to the shelf cap receiver 72 and/or the base section 32 in a similar fashion as the shelf fin 44 described above. In other various embodiments, referring to FIG. 7, the shelf fin 44 can be replaced by and/or used in conjunction with a product sample holder 41, for example, which can be attached to the display kit 30 in a similar fashion as the shelf fin 44. As illustrated in FIG. 33, various other components can be interchangeable with the shelf fin 44, such as the sample holder 41 and/or the product locator tabs 38, for example. In any event, each component can be attached to the display kit 30 in a similar fashion.

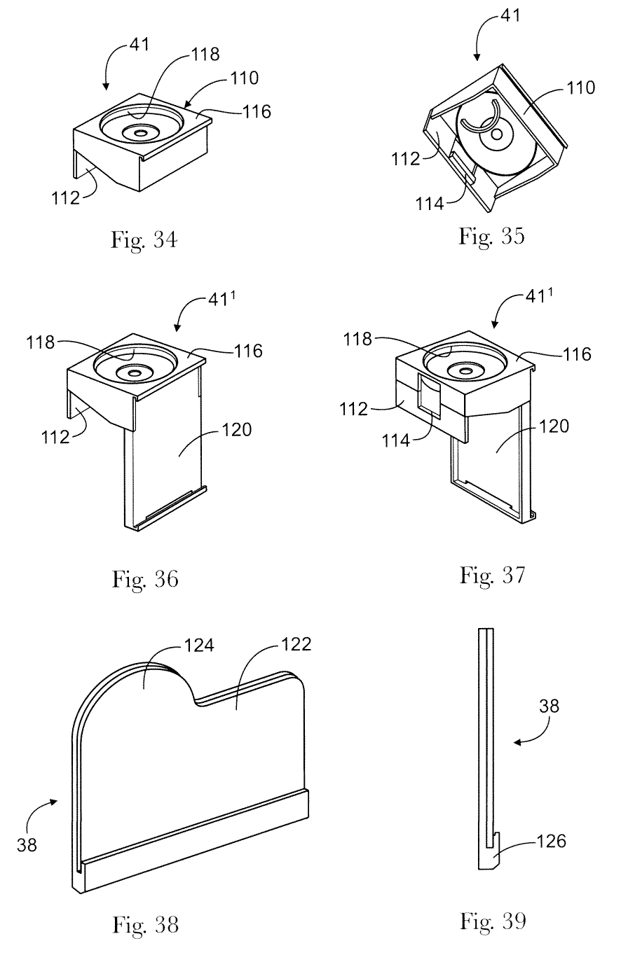

Further to the above, in various embodiments, the display kit 30 can include at least one product sample holder 41 configured to retain and display a sample retail product. In at least one embodiment, referring to FIGS. 7 and 33-35, the sample holder 41 can include a main body 110 having a projecting sidewall 112 extending therefrom. In such an embodiment, the projecting sidewall 112 can include a connection portion 114 configured to be engaged with a portion of the product display kit 30 and/or the shelf cap receiver 72 near the first end 48 of the base sections 32 in a similar fashion as the shelf fin 44 described above. In various embodiments, the main body 110 can include a face 116 having a product sample receiving aperture 118 defined therein, wherein the aperture can be configured to receive at least a base portion of a sample retail product (not illustrated) therein. In other various embodiments, referring to FIGS. 36 and 37, a sample holder 41′ can include an advertisement holder 120 positioned opposite the projecting sidewall 112, for example. In such an embodiment, the advertisement holder 120 can be configured to receive and display an advertising message and/or product information to a consumer.

Further to the above, in various embodiments, the display kit 30 can include at least one product locator tabs 38. In at least one embodiment, referring to FIGS. 2, 3, 6, 7, 8, 33, 38, and 39, the product locator tabs 38 can be configured to aid consumers in quickly navigating about the product display area and locating various retail products within the product display area in that the product locator tabs can be positioned such that they correspond with the various retail products within the product display area. In other various embodiments, the product locator tabs 38 can aid store personnel in restocking the retail products within the product display area by indicating where each retail product should be placed. In at least one embodiment, a product display tab 38 can be positioned intermediate two retail product dividers 42, for example, to indicate which retail product is positioned between the two dividers. In various embodiments, the product locator tabs 38 can include a first portion 122 configured to receive and display a retail product identifying message to a consumer, such as retail product type, for example. Further, the product locator tabs 38 can include a second raised portion 124 configured to display a number and/or a code, for example, related to a product information. In various embodiments, the product locator tabs 38 can also include a connector 126 configured to engage a portion of the product display kit 30 and/or the shelf cap receiver 72 in a similar fashion as the shelf fin 44 described above.

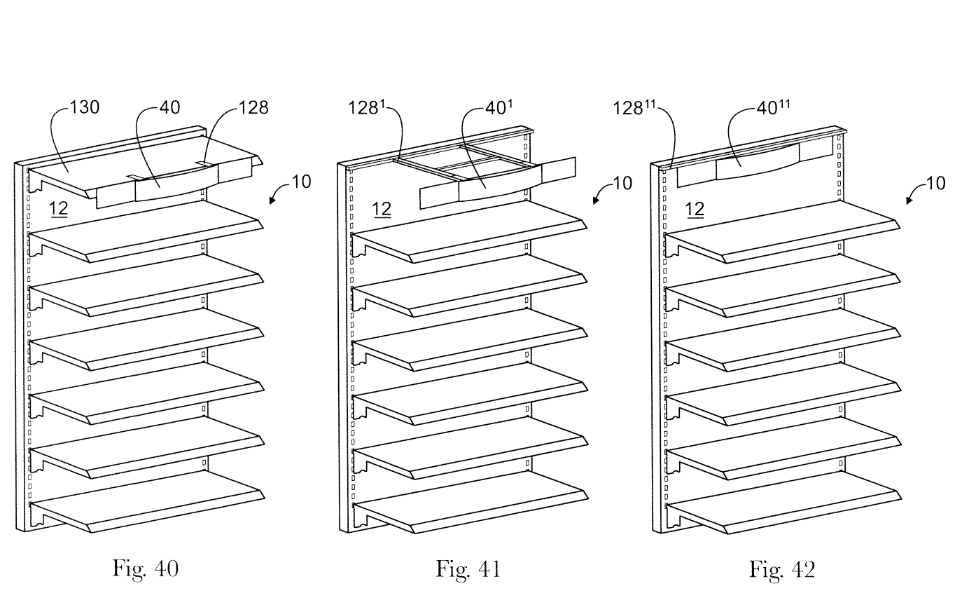

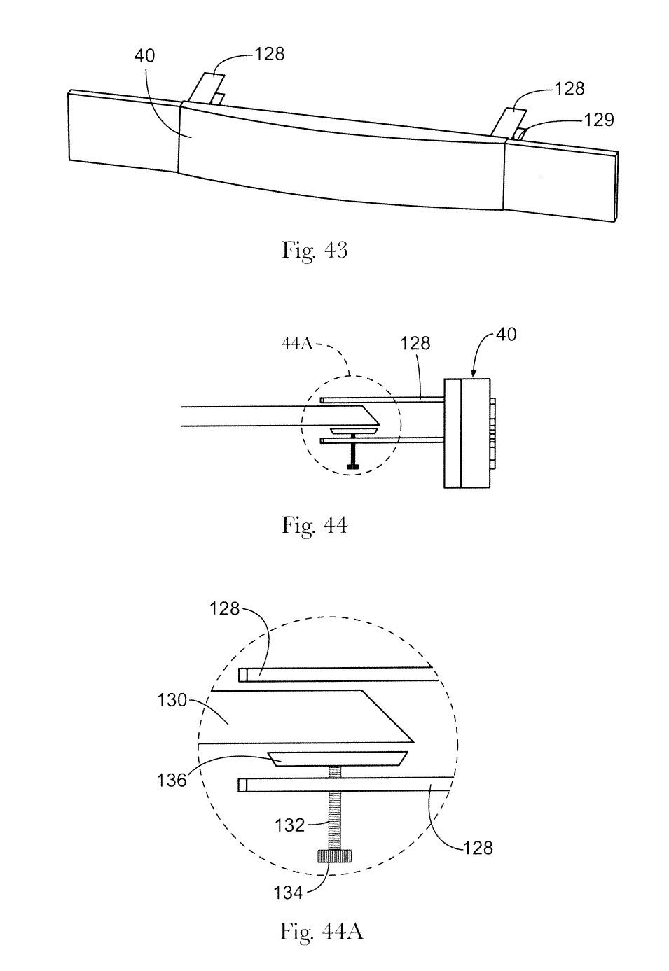

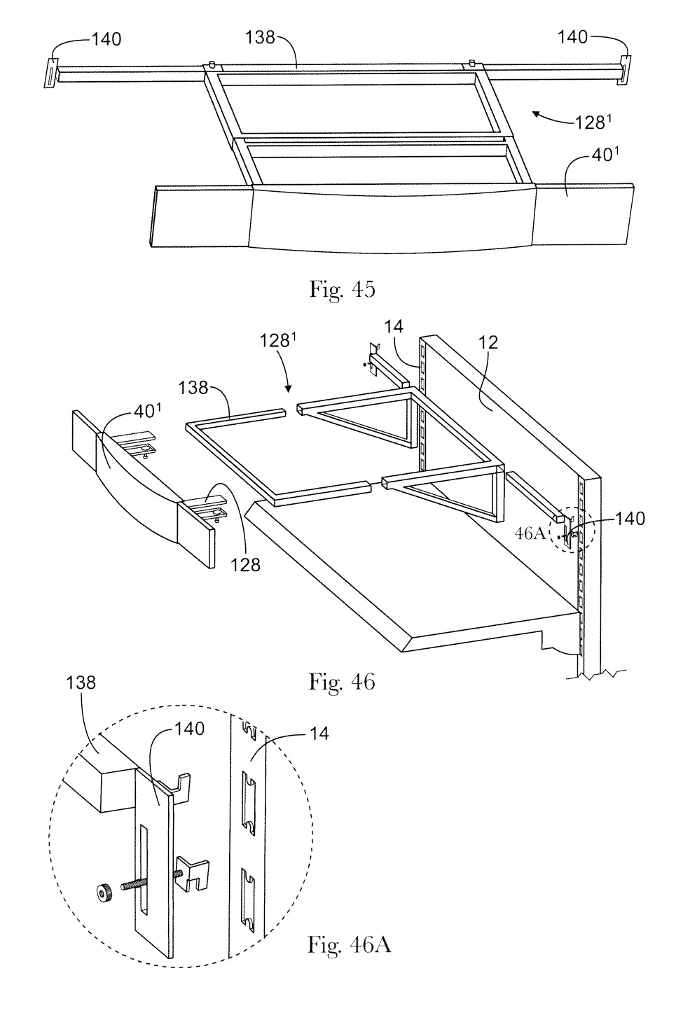

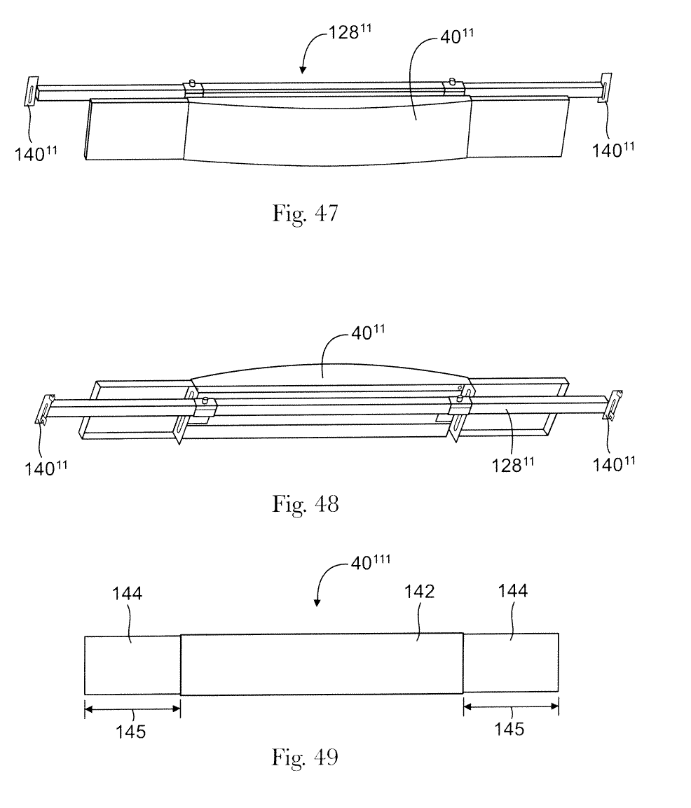

In addition to the various components of the product display kit 30 described above, the product display kit can further comprise a retail product logo portion which can be configured to display a retail product's brand, source, and/or logo to a consumer. In various embodiments, the retail product logo portion 40 can include many different configurations. As illustrated in FIGS. 2, 3, 40, 43, and 44, a retail product logo portion 40 can be configured to be attached to a bracket 128, wherein the bracket can be engaged with a top shelf 130 of the product display area 10. In various embodiments, referring to FIGS. 43 and 44, the bracket 128 can include at least one threaded aperture 129 defined therein, wherein a threaded screw 132 can be positioned through the aperture. In at least one embodiment, the threaded screw 132 can include a handle portion 134 on a first end and a shelf abutting member 136 on a second end. In such an embodiment, the threaded screw 132 can be rotated clockwise and/or counterclockwise to engage and disengage the shelf abutting member 136 with the top shelf 130 to thereby engage and disengage the retail product logo portion 40 with the top shelf 130. In other various embodiments, referring to FIGS. 41, 45, and 46, the retail product logo portion 40′ and the bracket 128 can be connected to a bracket 128′ using any suitable connection members. Bracket 128′ can include a frame 138 and bracket connection members 140, wherein the bracket connection members 140 can be used to connect the bracket 128′ to the shelf strips 14, for example. In such an embodiment, bracket 128 can be used to connect the retail product logo portion 40′ to the bracket 128′. In various embodiments, the bracket 128′ can be used when the product area display does not include a top shelf 130, for example, and/or when the retail product logo portion 40 needs to be positioned above the top shelf 130. In still other various embodiments, referring to FIGS. 42, 47, and 48, a bracket 128″ can be used with the retail product logo portion 40″ when it is desired to position the retail product logo portion proximate to the rear wall 12. In at least one embodiment, the bracket 128″ can be attached to the retail product logo portion 40″ and can include connection member 140″ configured to be attached to the shelf strips 14, for example. In any configuration, the various brackets and retail product logo portions can be mounted to each other and/or to the shelf strips 14 using any suitable mounting members, such as bolts and nuts, for example.

Further to the above, in various embodiments, referring to FIG. 49, a retail product logo portion 40′″ can include a main body 142 and two side portions 144. In at least one embodiment, the side portions 144 can be selectively slidable in the direction of arrow 145 into and out of slots (not illustrated) in the main body 142. In such an embodiment, the retail product logo portion 40 can be selectively adjusted to fit a particular dimension of a product display area in a retail store. Once the side portions 144 are slid to an appropriate position relative to the main body 142, the side portions can then be locked and/or latched in place using any suitable locking members and/or latching members. In other various embodiments, the side portions can include recesses, perforations, and/or score marks (not illustrated) which can be similar to that described herein. As described above in relation to other various components of the display kit 30, a piece of one or more of the side portions can be separated from the rest of the side portion to thereby fit the retail product logo portion to a dimension of a product display area and/or a shelf having any dimensions.

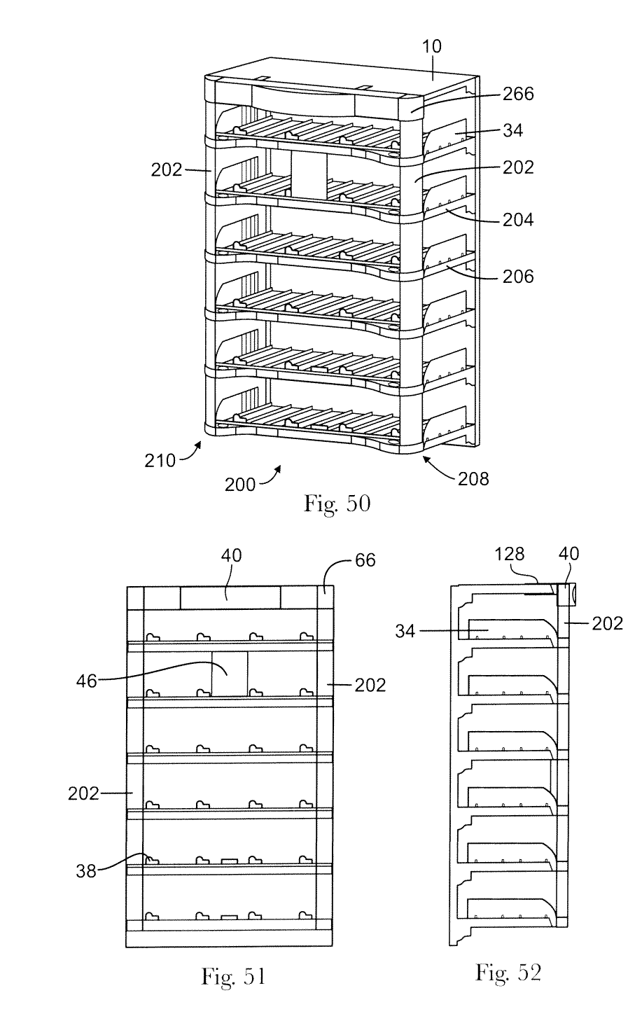

In other various embodiments of the modular retail product display kit, various other features, such as at least one column member, at least one sample holder, and at least one corner member, for example, can be included in addition to and/or in lieu of the various features described above. In at least one embodiment, referring to FIGS. 50-52, the product display kit 200 can be configured to be positioned on any existing product display area 10 (see, e.g., FIG. 1), an existing shelf, and/or any existing set of retail store shelves. In such an embodiment, the product display kit 200 can include a plurality of column members 202, as described in further detail below, wherein the column members 202 can be configured to extend intermediate a first shelf 204 and a second shelf 206 of the existing set of retail shelves. In a one-shelf product display area, the column members 202 can extend from the shelf in a direction perpendicular to and/or substantially perpendicular to the upwardly facing surface of the shelf. In various embodiments, the column members 202 can create the impression of columns on the set of shelves as illustrated in FIGS. 50 and 51, for example, even though the “column” may be separated by various shelves. In at least one embodiment, the columns created by the column members 202 can be positioned on a first side 208 and/or a second side 210 of the existing set of shelves, for example.

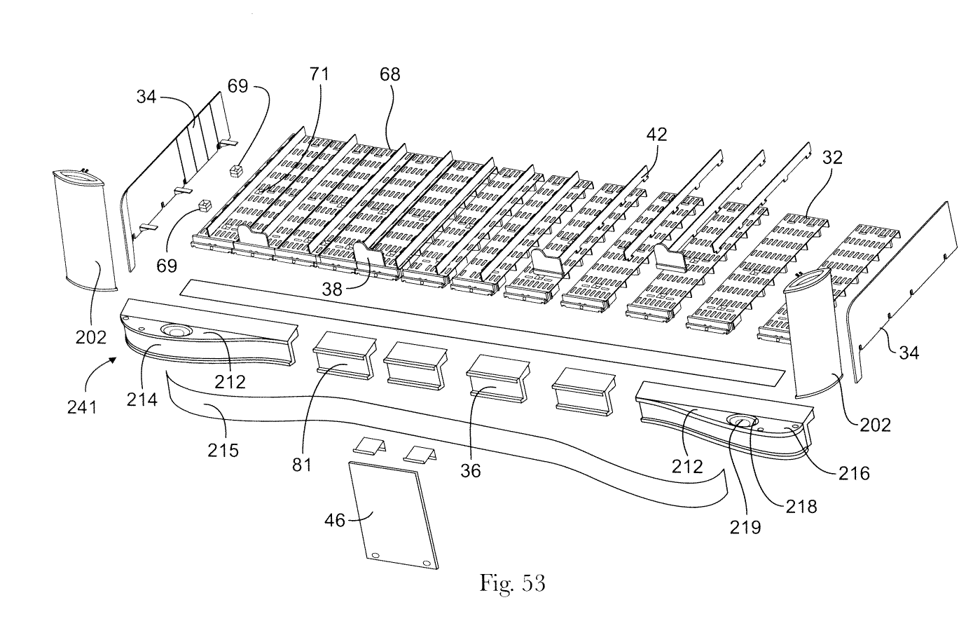

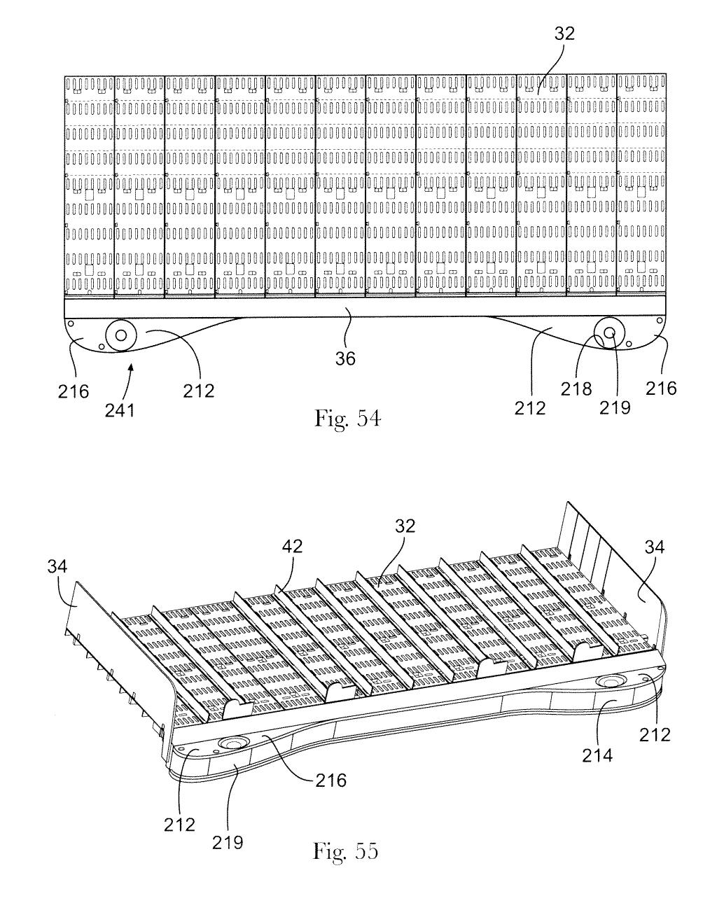

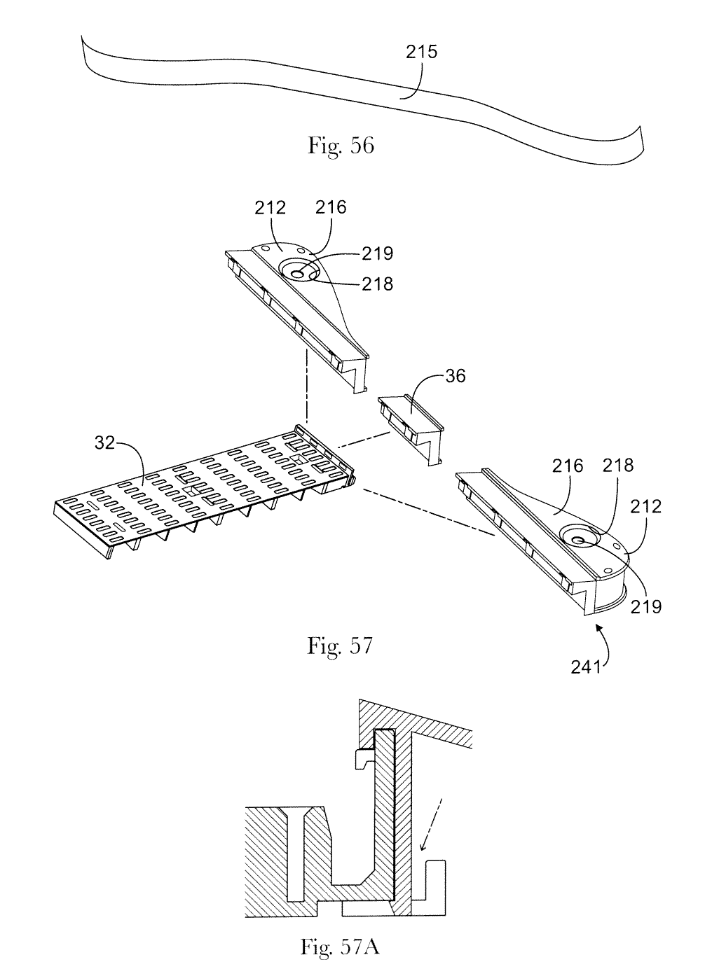

Further to the above, in various embodiments, sample holders 241 can be configured to be positioned on the product display area such that the sample holders can receive and display a sample retail product to consumers. In at least one embodiment, one or more sample holders can be positioned proximate to at least one shelf of the existing set of shelves, for example. In various embodiments, referring to FIGS. 53-57, the sample holders 241, can be similar to the shelf cap members 36 described above; however, the sample holders 241 can include an additional sample holding portion 212 which can be attached to the front face 81 of the shelf cap members 36 and/or formed integrally therewith. In at least one embodiment, the sample holding portion 212 can include an arcuate face 214 configured to provide the product display kit with an attractive aesthetic appearance configured to attract consumers to the product display area. In various embodiments, referring to FIG. 56, an advertising display 215 can be attached to the arcuate faces 214 of the sample holding portions 212 and/or the slots defined in the shelf cap members 36 as discussed above. In at least one embodiment, the sample holding portions 212 can each include a top surface 216 having a recess 218 defined therein. In such an embodiment, the recess 218 can be configured to receive at least a portion of a sample retail product to display the sample retail product to consumers. In various embodiments, the sample holders can include any other suitable configuration which is configured to hold a sample retail product and enhance the aesthetic appeal of the product display kit 200.

Further to the above, in various embodiments, the sample holders 41, 41′, and/or 241 can include a retractable elongate member (not illustrated), such as a flexible cord or a string, for example, configured to be coiled around a rotatable spool and/or engaged with another suitable extension/retraction device. In such an embodiment, the retractable elongate member can be used to retain a sample retail product to the sample holders 41, 41′, and/or 241, for example, to prevent consumers from removing the sample retail product from the product display area. In at least one embodiment, the recess 218 of the sample holders 241 can include an aperture 219 defined therein, wherein the aperture can be configured to slidably accept a portion of the retractable elongate member therethrough.

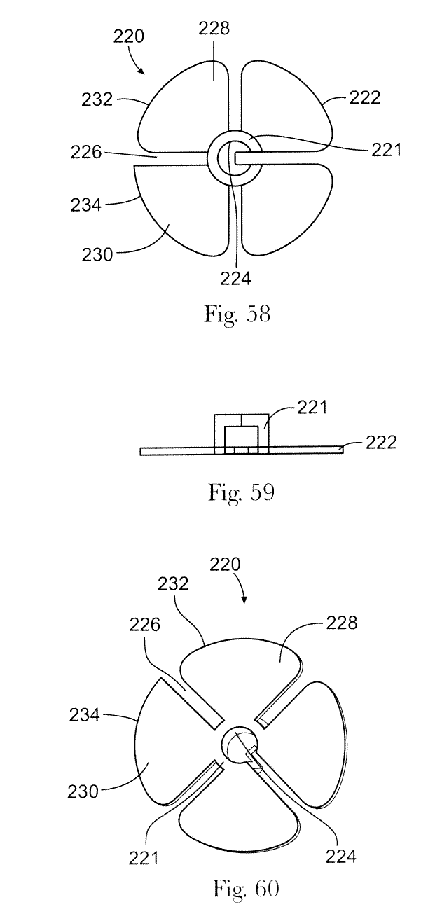

In various embodiments, referring to FIGS. 58-60, a sample retail product retaining member 220 can be configured to be engaged with a bottom portion of a sample retail product (not illustrated) at least partially positioned within the recess 218 such that a consumer cannot walk away from the product display area with the sample product and/or remove the sample product more than a few feet from the recess 218 owing to the length of the retractable elongate member. In at least one embodiment, the retaining member 220 can be at least partially comprised of a flexible material and can include an outer perimeter 222 which can be frictionally engaged, snap-fit, and/or press-fit with the bottom portion of the sample retail product. In such an embodiment, the retaining member 220 can further include an aperture 224 defined in a central portion 221 thereof. In at least one embodiment, an end portion of the retractable cord and/or a connection member on an end of the retractable elongate member can be configured to be engaged with the aperture 224 such that the retractable elongate member can be attached to the retaining member 220. In such an embodiment, the retaining member 220 can then be secured to the bottom of the sample retail product, for example. In various embodiments, the central portion 221 can extend from the retail product retaining member 220. In at least one embodiment, the retaining member 220 can include at least one slot 226 defined therein, wherein the slot can be configured to intersect with and define a recess in the outer perimeter 222. In such an embodiment, the slot 226 can define a first portion 228 and a second portion 230 in the retaining member 220, wherein the first portion can include a first arcuate face 232, wherein the second portion can include a second arcuate face 234, and wherein the first and second arcuate faces can be configured to be frictionally engaged, press-fit, and/or snap-fit with the bottom portion of the sample retail product such that the retaining member 200 can be retained to the bottom of the sample retail product.

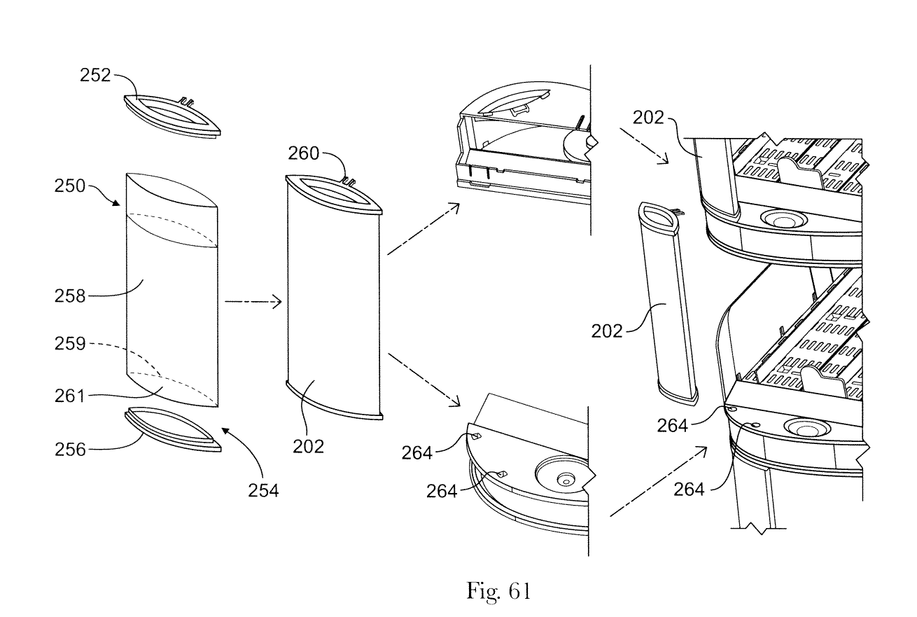

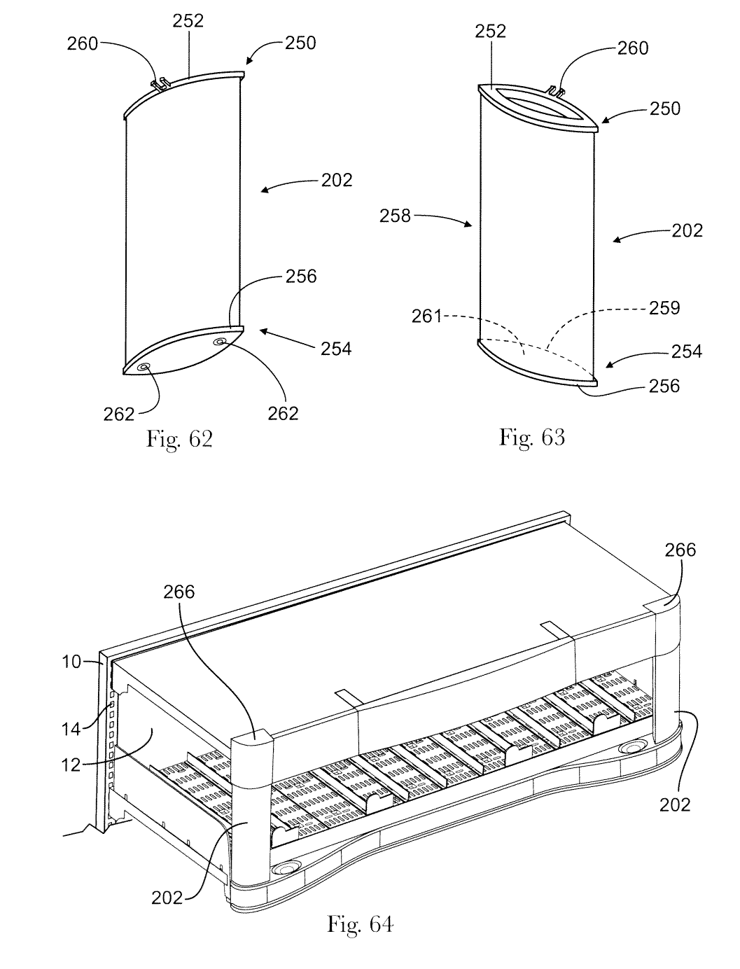

As described above, in various embodiments, the product display kit 200 can include a plurality of column members 202 which can be positioned on a first side 208 and/or a second side 210 of the existing set of shelves and/or the product display area. In at least one embodiment, referring to FIGS. 50-53, 61, 62, and 63 the column members 202 can be positioned intermediate each shelf of the existing set of shelves. In such an embodiment, the column members 202 can include a top portion 250, including a first cap 252, and a bottom portion 254, including a second cap 256. In various embodiments, the first and second caps can be attached to and/or integrally formed with a main body 258 of the column members 202. In at least one embodiment, one of the top portion 250 and the first cap 252 can include an engagement member 260 projecting therefrom, wherein the projection member can be configured to be attached to a first aperture or connector (not illustrated) defined in a portion of the sample product holder 241 and/or a portion of the base sections 32, for example. Further to the above, one of the bottom portion 254 and the second cap 256 can include at least one hook member 262 extending therefrom, wherein the hook member 262 can be engaged with a second aperture 264 or connector in a portion of the sample product holder 241 and/or a portion of the base sections 32, for example. In such a fashion, referring to FIG. 61, the column members can be engaged with the product display kit 200 on an existing set of shelves.

Further to the above, in various embodiments, the column members 202 can be adapted to be fit intermediate any set of retail store shelves having any dimensions. Similar to various components of the product display kit discussed herein, referring to FIGS. 61 and 63, the main body 258 can include a plurality of recesses, perforations 259, and/or score marks defined therein and extending in any suitable direction. In at least one embodiment, a portion 261 of the main body can be separated from the main body 258 along the recesses, perforations, and/or score marks to adapt the column members 202 for any suitable dimension between the various shelves. As discussed herein, because of the adjustability of the column members, among other features, the display kit 200 can easily be configured for use on almost any set of retail store shelves.

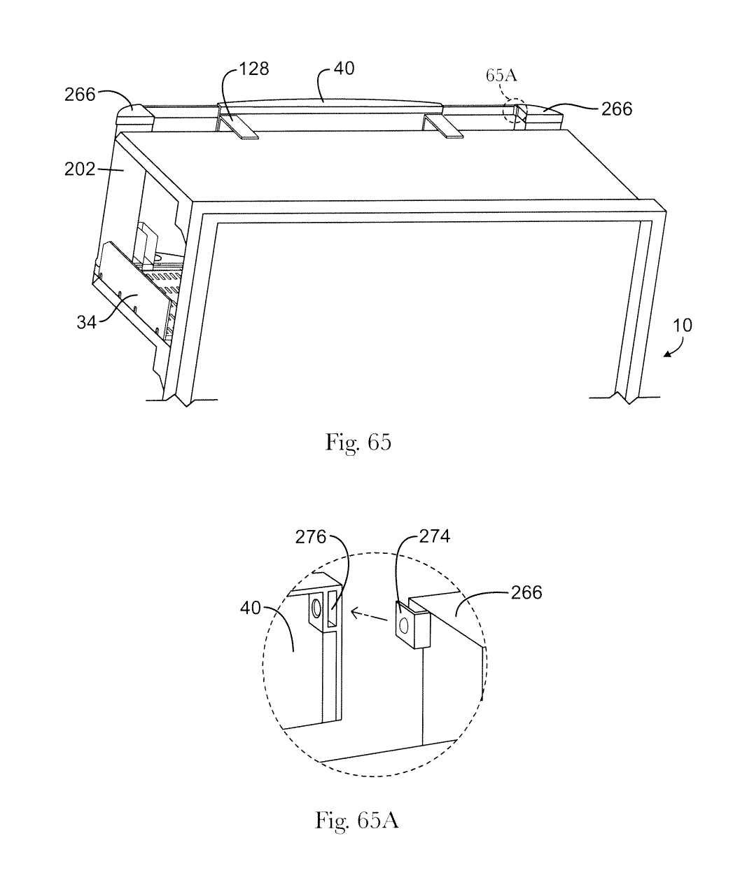

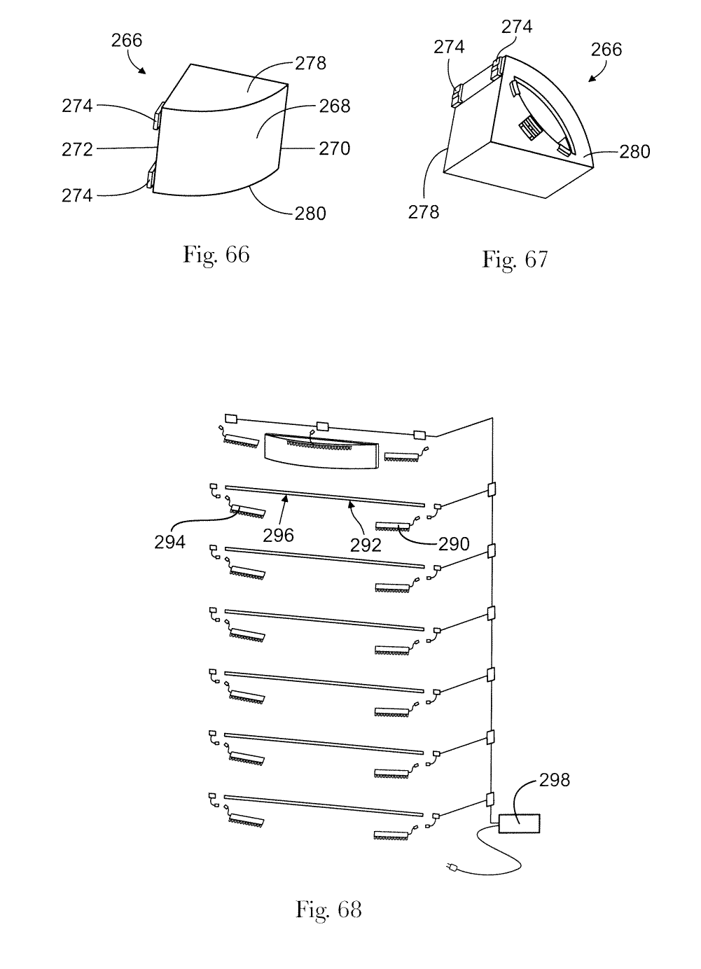

In various embodiments, when the column members 202 are included in the display kit 200, at least one corner member 266 can be engaged with a portion of a topmost column member and/or a portion of the retail product logo portion 40, for example. In such an embodiment, referring to FIGS. 64-67, the corner member 266 can include an arcuate face 268 which can have a first side 270 and a second side 272. In at least one embodiment, one of the first and second sides can include hooks 274 positioned proximal thereto and/or extending therefrom, wherein the hooks can permit the corner members 266 to be engaged with the hook receiving portions 276 (FIG. 65) of the retail product logo portion 40, for example. In such an embodiment, the hooks 274 can be slidably engaged with the hook receiving portions 276 to connect the corner members 266 to portions of the retail product logo portion 40. In various embodiments, the corner members 266 can also include a top end 278 and a bottom end 280. In such an embodiment, the bottom end 280 can be configured to be connected to a top portion 250 and/or a first cap 252 of a column member, for example.

In various embodiments, lighting can be included in any of the product display kits discussed above. In at least one embodiment, referring to FIG. 68, the lighting can include at least a first lighting element 290 at least partially encased in a first container 292, and at least a second lighting element 294 at least partially encased in a second container 296. In such an embodiment, the first and second lighting elements can include a plurality of light emitting diodes (“LEDs”) configured to illuminate at least a portion of the product display area, a product sample, and/or various retail products within the product display area, for example. In various embodiments, the first and second containers can be at least partially comprised of a transparent material such that the LEDs can emit light from within the containers, for example. In at least one embodiment, the containers can be glass tubes having lengths of 5-50 mm or, more preferably, 10 mm, for example. In various embodiments, the containers can each include a first end and a second end. In such an embodiment, the first end of a first container can be connected to a second end of a second container to form a chain of containers, for example. In other various embodiments, the containers can be connecting using any suitable members and/or methods known in the art. In at least one embodiment, the lighting elements can be powered by a power source 298 located on and/or proximate to the product display area. In various embodiments, the lighting elements and containers can be strategically positioned on the product display area to enhance the aesthetic look of the product display kit. In various embodiments, the lighting system can be configured such that it produces a very minimal amount of heat to ensure safety of consumers and provide for retail product stability. If too much heat was generated by the lighting system, the heat could cause adverse consequences to the chemical properties of the retail products, for example.

The present invention can further comprise a method of displaying retail products on an existing shelf and/or set of shelves in a retail store, wherein each shelf can include an upwardly facing surface defined between a first end, a second end, a front side, and a rear side. In various embodiments, the method can include the step of adjusting, adapting, and/or interlocking a plurality of base sections to fit a first dimension of at least one of the retail store shelves. In at least one embodiment, the step of adjusting the plurality of base sections can further comprise separating a portion of each of the base sections along a recess, a perforation, and/or a score mark defined in each of the base sections to adapt the base sections to fit the first dimension of one of the shelves. In various embodiments, the method can further comprise the step of applying the plurality of base sections to the upwardly facing surface of at least one of the retail store shelves to form a base. In at least one embodiment, an attachment member having adhesive on a bottom portion thereof can be inserted into, engaged with, press-fit into, and/or snap-fit into, a recess in a base section to thereby attach the base section to the upwardly facing surface. In such an embodiment, the method can include adjusting, aligning, and/or leveling the base sections using the attachment member. In various embodiments, the method can further include the step of attaching a sample holder to one of the shelf or the base. In at least one embodiment, the method can further comprise the step of adjusting a retail product divider to fit a second dimension of at least one of the retail store shelves. In such an embodiment, the step of adjusting of the retail product divider can further include separating a portion of the retail product divider along a recess, perforation, and/or score marks defined in the retail product divider to adapt the retail product divider to fit the second dimension of at least one of the shelves. The retail product divider can then be engaged with the base. Once the base and retail product divider are positioned on one of the retail store shelves, a plurality of retail products can be positioned on and/or supported by the base on a first side and a second side of the retail product divider. In various embodiments, the method can further comprise applying a first product locator tab on the first side of the retail product divider to aid a consumer in locating a first of the plurality of retail products, and applying a second product locator tab on the second side of the retail product divider to aid the consumer in locating a second of the plurality of retail products.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Any documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A modular retail product display kit configured to be applied to a product display area, wherein the product display area includes one or more shelves, and wherein at least one of the shelves includes an upwardly facing surface defined between a first end, a second end, a front side, and a rear side, the product display kit comprising:
an adjustable base section configured to at least partially cover the upwardly facing surface of at least one of the shelves, wherein the adjustable base section is configured to support a plurality of retail products;
a shelf cap member configured to be positioned proximate to the front side of at least one of the shelves;
a sample holder configured to be attached to one of the shelf cap member, a shelf cap receiver, and the front side of at least one of the shelves, wherein the sample holder is configured to receive and display a sample retail product, and wherein at least one of the shelf cap member and the sample holder is configured to receive and display a first advertising message; and
a column member configured to display a second advertising message, wherein the column member is configured to be located proximate to an intersection of the front side and one of the first end and the second end of at least one of the shelves, wherein the column member is configured to at least partially extend intermediate a first portion and a second portion of the product display area, and wherein the column member is configured to be adjusted relative to a distance between the first portion and the second portion.

2. The product display kit of claim 1, further comprising a retail product logo portion configured to be attached to a portion of the product display area, wherein the retail product logo portion is configured to be selectively adjusted between a first position and a second extended position to fit a dimension of the product display area.

3. The product display kit of claim 1, further comprising a plurality of the adjustable base sections, wherein a dimension of each of the adjustable base sections is configured to be modified such that the plurality of the adjustable base sections can cover the upwardly facing surface of at least one of the shelves having any dimensions.

4. The product display kit of claim 1, wherein the adjustable base section is a first adjustable base section, the kit further comprising a second adjustable base section, wherein the first adjustable base section is configured to be interlocked with the second adjustable base section to form a base.

5. The product display kit of claim 1, wherein the adjustable base section includes a plurality of apertures defined therein, wherein the apertures are configured to receive at least a portion of a retail product divider such that the retail product divider can be engaged with the adjustable base section.

6. The product display kit of claim 1, further comprising a retail product divider, wherein the retail product divider includes one of recesses and perforations defined therein, wherein a portion of the retail product divider is configured to be separated from the retail product divider along one of the recesses and the perforations such that a dimension of the retail product divider can be adjusted relative to a dimension of at least one of the shelves.

7. The product display kit of claim 1, further comprising a shelf fin configured to extend in a direction substantially perpendicular to a face of the front side of at least one of the shelves, wherein the shelf fin is configured to receive and display a third advertising message, and wherein the shelf fin is configured to be attached to one of the shelf cap member, the shelf cap receiver, the sample holder, and at least one of the shelves.

8. The product display kit of claim 1, further comprising a plurality of product locator tabs positioned proximate to the front side of at least one of the shelves, wherein the product locator tabs are configured to correspond with the plurality of retail products supported by the adjustable base section such that a consumer can easily locate one of the plurality of retail products.

9. The product display kit of claim 1, wherein the column member is configured to vertically extend between the first portion and the second portion, and wherein the column member includes an arcuate face configured to receive and display the second advertising message.

10. The product display kit of claim 1, further comprising a first side portion configured to be attached to the adjustable base section proximate to the first end of at least one of the shelves, and a second side portion configured to be attached to the adjustable base section proximate to the second end of at least one of the shelves, wherein the first and second side portions each include one of recesses and perforations defined therein, wherein a piece of both of the first and second side portions is configured to be separated from the first and second side portions along one of the recesses and the perforations to modify the first and second side portions relative to a dimension of at least one of the shelves.

11. The product display kit of claim 1, further comprising a plurality of product locator tabs positioned proximate to the front side of at least one of the shelves, wherein the product locator tabs are configured to assist in restocking the retail products.

12. The product display kit of claim 1, further comprising a first lighting element at least partially encased in a first container, a second lighting element at least partially encased in a second container, wherein the first container is configured to be attached to the second container such that the first and second lighting elements can illuminate at least a portion of the product display kit.

13. The product display kit of claim 1, wherein the adjustable base section includes a recess defined therethrough, and wherein the recess includes a side wall, the product display kit further comprising an attachment member configured to be one of snap-fit, press-fit, and frictionally engaged with the side wall of the recess, wherein the attachment member includes an adhesive on a bottom surface thereof, and wherein the adhesive is configured to attach the adjustable base section to at least one of the shelves.

14. A modular retail product display kit configured to be applied to a product display area, wherein the product display area includes one or more shelves, and wherein at least one of the shelves includes an upwardly facing surface defined between a first end, a second end, a front side, and a rear side, the product display kit comprising:
a plurality of interlockable base sections configured to at least partially cover the upwardly facing surface of at least one of the shelves, wherein the interlockable base sections are configured to be adjusted relative to a dimension of at least one of the shelves;
a shelf cap member configured to be positioned proximate to the front side of at least one of the shelves;
a sample holder configured to be attached to one of the shelf cap member, a shelf cap receiver, and the front side of at least one of the shelves, wherein the sample holder is configured to receive and display a sample retail product, and wherein at least one of the shelf cap member and the sample holder is configured to receive and display a first advertising message; and
a column member configured to display a second advertising message, wherein the column member is located proximate to an intersection of the front side and one of the first end and the second end of at least one of the shelves, wherein the column member is configured to extend at least partially intermediate a first portion and a second portion of the product display area, and wherein the column member is configured to be vertically adjusted relative to the distance between the first portion and the second portion.

15. The product display kit of claim 14, further comprising a retail product logo portion configured to be attached to a portion of product display area, wherein the retail product logo portion is configured to be selectively adjustable at least between a first position and a second extended position such that the retail product logo portion can be adapted to fit a dimension of at least one of the shelves.

16. The product display kit of claim 14, wherein the plurality of the interlockable base sections each includes a plurality of one of recesses and perforations, wherein a dimension of each of the interlockable base sections is configured to be adjusted by separating a portion of the interlockable base sections along at least one of the recesses and the perforations such that each of the interlockable base sections can be adjusted relative to a dimension of at least one of the shelves.

17. The product display kit of claim 14, further comprising a retail product divider extending in a direction substantially perpendicular to the upwardly facing surface, wherein the retail product divider includes one of recesses and perforations defined therein, wherein a portion of the retail product divider is configured to be separated from the retail product divider along one of the recesses and the perforations such that a dimension of the retail product divider can be adjusted relative to a dimension of at least one of the shelves.

18. The product display kit of claim 14, further comprising a shelf fin configured to extend in a direction substantially perpendicular to a face of the front side of at least one of the shelves, wherein the shelf fin is configured to receive and display a third advertising message, and wherein the shelf fin is configured to be attached to one of the shelf cap member, the shelf cap receiver, the sample holder, and at least one of the shelves.

19. The product display kit of claim 14, wherein the column member is configured to vertically extend between the first portion and the second portion, and wherein the column member includes an arcuate face configured to receive and display the second advertising message.

20. The product display kit of claim 14, further comprising a product locator tab positioned proximate to the front side of at least one of the shelves, wherein the product locator tab is configured to correspond with at least one of the sample retail product and retail products supported by the interlockable base sections, and wherein the product locator tab is configured to assist in restocking the retail products.

21. The product display kit of claim 14, further comprising a first lighting element at least partially encased in a first container, a second lighting element at least partially encased in a second container, wherein the first container is configured to be attached to the second container such that the first and second lighting elements can illuminate at least a portion of the product display kit.

22. The product display kit of claim 14, wherein the interlockable base section includes a recess defined therethrough, and wherein the recess includes a side wall, the product display kit further comprising an attachment member configured to be one of snap-fit, press-fit, and frictionally engaged with the side wall of the recess, wherein the attachment member includes an adhesive on a bottom surface thereof, and wherein the adhesive is configured to attach the interlockable base section to at least one of the shelves.

23. A modular retail product display kit configured to be applied to a product display area, wherein the product display area includes one or more shelves, and wherein at least one of the shelves includes an upwardly facing surface defined between a first end, a second end, a front side, and a rear side, the product display kit comprising:
a plurality of interlockable base sections configured to at least partially cover the upwardly facing surface of at least one of the shelves, wherein the base sections are configured to support a plurality of retail products;
a shelf cap member configured to be positioned proximate to the front side of at least one of the shelves;
at least one sample holder configured to be attached to one of the shelf cap member, a shelf cap receiver, and the front side of at least one of the shelves, wherein the sample holder is configured to receive and display a sample retail product, and wherein at least one of the shelf cap member and the sample holder is configured to receive and display a first advertising message;
a plurality of product locator tabs positioned proximate to the front side, wherein the product locator tabs are configured to be used to direct a consumer to one of the plurality of retail products supported by the interlockable base sections, and wherein the product locator tabs are configured to correspond with at least one of the sample retail product and the plurality of retail products;
a retail product logo portion configured to be attached to a portion of the product display area, wherein the retail product logo portion is configured to be movable between a first position and a second extended position such that the retail product logo portion can be adapted to fit a dimension of the product display area; and
a retail product divider configured to extend from at least one of the plurality of interlockable base sections, wherein the retail product divider includes one of recesses and perforations defined therein, wherein a portion of the retail product divider is configured to be separated from the retail product divider along one of the recesses and the perforations such that a dimension of the retail product divider can be adjusted relative to a dimension of the product display area.

24. The product display kit of claim 23, wherein the plurality of interlockable base sections each include one of recesses and perforations, wherein a dimension of each of the plurality of interlockable base sections is configured to be adjusted by separating a portion of the interlockable base sections along at least one of the recesses and the perforations such that each of the interlockable base sections can be adapted to fit a dimension of at least one of the shelves.

25. The product display kit of claim 23, further comprising a shelf fin configured to extend in a direction substantially perpendicular to a face of the front side, wherein the shelf fin is configured to receive and display a second advertising message, and wherein the shelf fin is configured to be attached to one of the shelf cap member, the shelf cap receiver, the sample holder, and at least one of the shelves.

26. The product display kit of claim 23, wherein the product locator tabs are configured to assist in restocking the plurality of retail products supported by the interlockable base sections.

27. The product display kit of claim 23, further comprising a first lighting element at least partially encased in a first container, a second lighting element at least partially encased in a second container, wherein the first container is configured to be attached to the second container such that the first and second lighting elements can illuminate a portion of at least one of the shelves.

28. A product display, wherein the product display includes one or more shelves, and wherein at least one of the shelves includes an upwardly facing surface defined between a first end, a second end, a front side, and a rear side, the product display comprising:
a plurality of interlockable base sections configured to at least partially cover the upwardly facing surface of at least one of the shelves, wherein the interlockable base sections are configured to be adjusted relative to a dimension of at least one of the shelves;
a shelf cap member configured to be positioned proximate to the front side of at least one of the shelves;
a sample holder configured to be attached to one of the shelf cap member, a shelf cap receiver, and the front side of at least one of the shelves, wherein the sample holder is configured to receive and display a sample retail product, and wherein at least one of the shelf cap member and the sample holder is configured to receive and display a first advertising message; and
a column member configured to display a second advertising message, wherein the column member is located proximate to an intersection of the front side and one of the first end and the second end of at least one of the shelves, wherein the column member is configured to extend from at least one of the shelves, and wherein the column member is configured to be vertically adjusted relative to dimensions of the product display.

29. A method of displaying a retail product on a product display area, wherein the product display area includes one or more shelves, wherein each shelf includes an upwardly facing surface defined between a first end, a second end, a front side, and a rear side, the method comprising:
interlocking at least two base sections to fit a first dimension of at least one of the shelves;
applying the at least two base sections to the upwardly facing surface of at least one of the shelves to form a base;
attaching a sample holder to one of the shelves or the base;
adjusting a retail product divider to fit a second dimension of at least one of the shelves;
engaging the retail product divider with a portion of the base;
positioning a plurality of retail products on the base on a first side and a second side of the retail product divider;
applying a first product locator tab on the first side of the retail product divider to aid a consumer in locating a first of the plurality of retail products; and
applying a second product locator tab on the second side of the retail product divider to aid the consumer in locating a second of the plurality of retail products.

30. The method of claim 29, further comprising adjusting the at least two base sections by separating a portion of each of the base sections along one of a recess and a perforation defined in each of the base sections to adapt the base sections to fit the second dimension of at least one of the shelves.

31. The method of claim 29, wherein the adjusting of the retail product divider further comprises separating a portion of the retail product divider along one of a recess and a perforation defined in the retail product divider to modify the retail product divider to fit the second dimension of at least one of the shelves.

32. The method of claim 29, wherein at least one of the base sections includes a recess, further comprising the step of engaging an attachment member with the recess to attach the base to at least one of the shelves.

33. A sample product retaining member configured to be engaged with a sample retail product having a bottom portion, wherein the sample product retaining member is configured to retain the sample retail product to a retail product display area, the sample product retaining member comprising:
an outer perimeter, wherein at least a portion of the outer perimeter is configured to be engaged with the bottom portion of the sample retail product;
an aperture defined in a central portion of the retaining member, wherein at least a portion of a flexible elongate member is configured to be engaged with the aperture to retain the sample product to the retail product display area; and
at least one slot defined in the sample product retaining member.

34. The retaining member of claim 33, wherein the slot defines a first portion and a second portion of the retaining member, wherein the first portion includes a first arcuate face, and wherein the second portion includes a second arcuate face, and wherein the first and second arcuate faces are configured to be engaged with the bottom portion of the sample product such that the retaining member can be retained to the sample product.
